(19) United States
(12) Patent Application Publication
(10) Pub. No.: US 2007/0016862 A1
(43) Pub. Date: Jan. 18, 2007

(54) Input guessing systems, methods, and computer program products

(75) Inventor: Yevgeniy Kuzmin, Staten Island, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Microth, Inc.

(21) Appl. No.: 11/487,269

(22) Filed: Jul. 14, 2006

Related U.S. Application Data
(60) Provisional application No. 60/699,973, filed on Jul. 15, 2005.

(51) Int. Cl. G06F 3/00

(52) U.S. Cl. 715/700

(57) ABSTRACT

Provided are systems for acceleration of text input for electronic devices, such as efficient and user-friendly input guessing systems for mobile phones. An input guessing system disambiguates user input to decrease the number of required key strokes for entry of desired input. An input guessing system uses one or more of optimal selection of a candidate word and position of the cursor within or after the candidate word based on minimization of expectation of the total weighted number of input events for all words, advanced disambiguating of input events, reduced ambiguity of a group containing a letter in a current position of the cursor, smart processing of word endings, advanced delimiting of words using an OK key, automatic addition of spaces, simple error correction, the ability to generate words with embedded special accented characters by typing the key associated with the unaccented version of the letter, and the ability to automatically disambiguate among multiple punctuation characters assigned to a single key based on the context of the keystroke to accelerate and simplify user input.

### CROSS-REFERENCE TO RELATED APPLICATION

This application claims priority to and the benefit of the filing date of provisional application entitled “Input Guessing Systems, Methods, and Computer Program Products,” assigned Ser. No. 60/699,973 and filed Jul. 15, 2005, which is incorporated by reference.

### FIELD OF THE INVENTION

The present invention relates generally to systems, methods, and computer program products for acceleration of input for electronic devices and, more particularly, to input guessing systems, methods, and computer program products for acceleration of input and efficient and user-friendly input of text entry for portable electronic devices.

### BACKGROUND

As the functionality of portable electronic devices continues to increase, most such devices require alphanumeric input and extended controls. Several solutions for data entry input for such devices exist like compact and/or reduced keyboards, handwriting recognition, and voice recognition.

For various reasons, these and other conventional input solutions are often involve ambiguous input. For example, several symbols may be pre-assigned to one input key, letters may be represented by very close sounds (b,p,v), entered symbols may have very similar handwritten shapes (h,n), or close buttons may be pressed simultaneously using a miniature keyboard.

There exist many methods to disambiguate input at the letter level. For example, text input on mobile phones commonly uses a multitap method. To enter a symbol, it is typically necessary to press a key several times depending on the pre-assigned position of the symbol to a key. For example, to enter “R” being the third letter pre-assigned to the key “7”, the user should press the key three times. On average, it is necessary to make about 2.1 keystrokes to enter a letter using a multitap method.

Another method of letter disambiguating referred to as LetterWise and described in U.S. Pat. No. 6,219,731 assigned to Eatoni Ergonomics, Inc., of New York, N.Y., is based on analysis of most frequent letter combinations and predicts a most frequent letter following some prefix. LetterWise is a more efficient input method than multitap and requires about 1.15 keystrokes per symbol.

To increase speed of input, many of input methods may be combined with conventional word prediction methods, also referred to as predictive text input. This is a common solution for unambiguous keyboards, keyboards on which each keystroke or combination of keys corresponds to a symbol, such as a Qwerty keyboard. Word prediction generates a list of possible words in the order of their frequency after the input of just a few first letters of a word, and a user may select a word in this word list if the desired word appears in the word list.

Word prediction methods may be used even with an ambiguous input. However, an ambiguous predictive text input has a drawback of typically generating a large list of candidate words matching an ambiguous input. For instance, the phone keystroke sequence 2-2-7-3-7 corresponds to 432 different letter sequences (with the standard assignment of letters to keys). Of these, 13 are words in English: acres, bards, barer, bases, bares, baser, cards, carer, cares, caser, cases, caper, and capes. The selection of a desired word in such list may then require a lot of additional keystrokes.

Another problem of ambiguous word prediction methods is that typical mobile devices such as cellular phones have small screens. In such cases, there may be no space to display a list of words, or often only the one most frequent word may be displayed. Displaying the most frequent word or a list of words also leads to an unstable, “jumpy” display when the most frequent word or the list of displayed words may be changing in part or completely as input continues. A changing word or a list of words can confuse a user, because the displayed words may be entirely different from a desired word. And after all, if finally the displayed word is still incorrect a user needs to scroll down through all the possible words in the word list and select the desired word from the list, if it appears in the list.

Another problem of conventional predictive input is a lack of system feedback. This is especially a problem when the user makes a spelling or keystroke error, since due to the nature of ambiguous predictive input and changing displayed words, errors typically are not detected immediately, but at later stages of input or after completing a word input. Often it is too late or difficult to correct an earlier input error, and the user is forced to completely re-enter the device word. Having to re-enter a desired word can be very frustrating to users.

Another problem of ambiguous word prediction is dealing with non-dictionary words, like slang, names, abbreviations, terminology, etc. Because if as many as 15% of words are not in a dictionary of the predictive system, then word-based predictive text input methods become even slower for non-dictionary text input than multitap methods and the efficiency of word prediction systems drops by half compared to input of dictionary words. One reason for the drop in efficiency is that word input processes typically become very complex when entering a non-dictionary word: a user searches the word list, realizes that the desired word is not in the list, erases the wrong word, switches to multitap mode, completely re-enter the word using multitap, and then switches back to predictive mode. Often after switching to a user may prefer to continue input in multitap mode. For further description of LetterWise, multitap, multitap mode, and disambiguation, see MacKenzie, I. S., Kober, H., Smith, D., Jones, T., and Skepner, E., “LetterWise: Prefix-based Disambiguation for Mobile Text Input,” Proc UIST 2001, 111-120.

Another problem with a predictive text input is ergonomics. The manual selection of a desired word from a prediction list requires a user to switch his or her focus of attention and, therefore, slows the user and input speed and increases the number of keystrokes required to enter a given segment of text.

Different word prediction methods have been proposed for ambiguous predictive word input, such as eZiText from Zi Corporation (www.zicorp.com), T9 by Tegic Communications (www.tegic.com), or iTAP from the Lexicus Division of Motorola (www.motorola.com/lexicus) and may be able to achieve an efficiency of about one keystroke per character (kspc) for dictionary words, but still involve the aforementioned problems.

Accordingly, improved input guessing systems, methods, and computer program products are desired to provide acceleration, improved efficiency, and user-friendly input of text entry for electronic devices.

### SUMMARY

In light of the foregoing background, embodiments of the present invention provide improved systems, methods, and computer program products for input guessing text for electronic devices.

An objective of the present invention to provide efficient, user-friendly, intuitive input guessing text, symbol, word, command, etc. input for, but not limited to, portable electronic devices.

An additional objective of the present invention is to provide input guessing systems, methods, and computer program products that can be combined with different basic input methods for, but not limited to, keypads, keyboards, gesture and handwriting input, and voice recognition.

Another objective of the present invention is to provide input guessing systems, methods, and computer program products supporting different methods of ambiguity resolution and resulting in accelerated text, symbol, word, and/or command input.

Yet another objective of the present invention to provide an input guessing system without displaying and selection of candidates in word lists.

A further objective of the present invention is to provide an input guessing system that is suited for input of non-dictionary words.

A further objective of the present invention is to provide an input guessing system with simple error correction methods.

A further objective of the present invention is to provide an input guessing system that is both language and alphabet independent while also being capable of simple customization to individual input styles, contexts, applications, and dictionaries.

A further objective of the present invention is to provide an input guessing system that utilizes information about word combinations, such as the parts of speech of word combinations and frequency pairings of word combinations.

To differentiate embodiments of the present invention from conventional word prediction systems, embodiments of the present invention are referred to herein as input guessing systems, methods, and computer program products.

One embodiment of the present invention may provide a data entry system for a portable electronic device.

Another embodiment of the present invention may provide a data entry system for different applications and/or content. For example, a dictionary for a data entry system may be created based on a content specific set of words or phrases with different frequency weightings. For example, for a GPS system a dictionary may contain city names weighted by their populations. For music players, a dictionary may contain names of artists and songs and use artist and song popularity charts for weighting. For an address or contact application, a dictionary may use the names of persons in a contact list weighted by frequency of usage. For an internet browser, a dictionary may contain names of websites visited by a user. For a search system, a dictionary may contain a list of search terms. Generally, any application requiring text input may have its own dictionary for an input guessing system. These dictionaries may be dynamic and updated when new words are entered in the related application, and a dictionary may also be updated when weights of words are changed, such as when an artist or song popularity chart changes or a user increasingly visits a particular website.

Embodiments of methods for input guessing of the present invention corresponding to the above-described systems of the present invention are provided herein and further described and claimed below.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is an embodiment of a standard phone layout for a user interface and data entry apparatus capable of operating in accordance with an embodiment of an input guessing system of the present invention;

FIG. 2A presents a flow diagram of a process of user interaction for an embodiment of an input guessing method of the present invention;

FIG. 2B presents another flow diagram of a process of user interaction for an embodiment of an input guessing method of the present invention;

FIG. 3 presents part of an English word dictionary tree for letters assigned to the “9” key of phone keypad in accordance with an embodiment of an input guessing system of the present invention;

FIG. 4 illustrates an embodiment of the top level of a state tree for English languages based on British National Corpus statistics;

FIG. 5 illustrates a grouping of Korean jamos for a phone keypad for use in accordance with an embodiment of an input guessing system of the present invention;

FIG. 6 illustrates a grouping of basic Japanese kana symbols for a phone keypad for use in accordance with an embodiment of an input guessing system of the present invention;

FIG. 7 illustrates a miniature gesture input device having four sensitive zones for use in accordance with an embodiment of an input guessing system of the present invention;

FIG. 8 illustrates different states of input guessing system with direct cursor placement depending on position of the cursor in accordance with an embodiment of an input guessing system of the present invention;

FIG. 9 illustrates three consecutive states of a dynamic 12-button keypad for input of a first letter of a word in English in accordance with an embodiment of an input guessing system of the present invention;

FIG. 10 illustrates a dynamic pop-up display for 8-directional gesture input for touch sensitive screens operating in accordance with an embodiment of an input guessing system of the present invention;

FIG. 11 illustrates an example structure of a dictionary tree in accordance with an embodiment of the present invention;

FIG. 12 illustrates an example structure of a tree with an assigned determinate stem in accordance with an embodiment of the present invention;

FIG. 13 illustrates an example structure of a tree with assigned guessing stems in accordance with an embodiment of the present invention;

FIG. 14 illustrates an example structure of a tree with assigned guessing words in accordance with an embodiment of the present invention;

FIG. 15 illustrates an example initial structure of a tree before stem assignment in accordance with an embodiment of the present invention;

FIG. 16 illustrates an example structure of a tree with an assigned stem in accordance with an embodiment of the present invention;

FIG. 17 illustrates an example initial structure of a tree before word assignment in accordance with an embodiment of the present invention;

FIG. 18 illustrates an example structure of a tree with an assigned word in accordance with an embodiment of the present invention;

FIG. 19 illustrates an example structure of a tree for sequential disambiguating in accordance with an embodiment of the present invention;

FIG. 20 illustrates an example structure of a tree for dynamic sequential disambiguating in accordance with an embodiment of the present invention;

FIG. 21 illustrates an example structure of a tree with combined guessing and disambiguating in accordance with an embodiment of the present invention;

FIG. 22 illustrates an example structure of a tree for letter guessing in accordance with an embodiment of the present invention;

FIG. 23 illustrates an example structure of a tree for index disambiguating in accordance with an embodiment of the present invention; and

FIG. 24 illustrates an example structure of a tree for hierarchical disambiguating in accordance with an embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While a primary use of the present invention may be in the field of data entry, principally word input, for portable electronic devices such as mobile phones and portable computers, it will be appreciated from the following description that the invention is also useful for many types of devices that are generally referenced herein as mobile terminals, including, for example, mobile phones, smart phones, portable personal audio and video players, pagers, portable data terminals and personal data assistants (PDAs), portable medical devices, portable personal computer (PC) devices, portable global positioning system (GPS) receivers, electronic dictionary or translator devices, personal information managers, labelers, smart watches, and other portable electronics, including devices that are combinations of the aforementioned devices. Similarly, one of ordinary skill in the art will recognize that, while the present invention is particularly useful for mobile devices, the present invention can be used with other devices and systems and fixed devices and systems, such as desktop personal computers (PCs) and different home and office appliances and control devices for them.

While a primary input device for an embodiment of the present invention may be a keypad with reduced number of keys with a group of symbols assigned to keys, such as keypads of mobile phones, it will be appreciated from the following description that the invention is also useful for many other of input devices and input methods, including, for example, full-size keyboard input, handwriting input, gesture input, audio input, and any other methods generating input events associated with data and text entry and other input selection activities. Such input methods may be implemented using different hardware, including, for example, but not limited to, touch screens, key arrays, joysticks, directional pads, touch and force sensitive pads, dials, etc.

Similarly, one of ordinary skill in the art will recognize that, while the present invention is particularly useful for text input, the present invention can be used for input of other commands and control actions, such as application and device controls operations. Further, to simplify the description of the present invention, the term “word” is often used to describe a desired input or a resulting display, however, except as limited by the context of the use of the term “word,” as used herein, the term “word” typically refers to a word as understood in the sense of a written language, but more generally refers to different types of input, including, but not limited to, text, letters, symbols, numbers, commands, and like combinations or sequences of the proceeding inputs.

An embodiment of the present invention provides an input guessing system that includes an input, a processing device, and a display device. These devices may be combined together, or any of the processing device, input device, and display may be a separate device from the other devices. These devices also may be hardwired or communicate wirelessly.

An input device may be configured to detect inputs of different input implements such as input devices and systems described in U.S. Provisional Patent Application No. 60/581,064, entitled “Stroke-Based Data Entry System and Method” and filed Jun. 18, 2004, and in a corresponding International Patent Application filed under the Paris Convention Treaty, entitled “Stroke-Based Data Entry Device, System, and Method” and filed Jun. 16, 2005, which are incorporated herein by reference in their entireties. An input device may accept data input from input devices including, but not limited to, keyboards, keypads, touch pads or screens, handwriting input, stroke or gesture input, and audio input. Input events accepted by input devices may be ambiguous if having more than one meaning. Many embodiments of the present invention also rely upon three additional unambiguous input events: OK, back, and forward for control of input guessing systems. In other embodiments, these three unambiguous input events may be absent or combined with other input events.

In an embodiment of an input guessing system of the present invention, a processing device may be capable of input ambiguity resolution (disambiguating) from a selection of the best candidate word based on partially unambiguous and partially ambiguous input and cursor positioning in the candidate word.

An input guessing system of the present invention may include a dictionary of words which is organized in a tree with stem/word frequency information in every node. Based on this tree, an input guessing system of the present invention may build a state tree with words or parts of words assigned to nodes and branches corresponding different input events. Example data structures and algorithms for creation of trees are described below with respect to additional description of embodiments of the present invention.

A processing device may include an electronic circuit which registers and processes input events. At any moment of input, the processing device displays a candidate word and places the cursor at a calculated best position for additional input within or after the word. The selection of the displayed candidate word and position of the cursor in the word or after the word are based on minimization of the expectation of a total number of input events for all words in the dictionary weighted by frequencies of their use. The process of selection of the candidate word and position of the cursor is described below with respect to additional description of embodiments of the present invention.

At any moment of input, a user may either continue input (enter a new input event), or accept the displayed sequence (for example by input of “OK” command), or move the cursor to the first incorrect letter in the input sequence. Depending on the position of the cursor and the first incorrect letter in the word, a user may input “BACKWARD” if the first incorrect letter is before (to the left of) the cursor, or “FORWARD” if the first incorrect letter is after (to the right of) the cursor. A user also or alternatively may directly position the cursor at the first incorrect letter by pointing an input device at that letter and cursor position.

After each input event the ambiguity of the input is reduced, and the part of the word before the first incorrect letter becomes unambiguous and will not be changed during further input unlike conventional ambiguous word prediction systems which try to resolve ambiguity at the end of a word using a complete input. The disclosed method resolves ambiguity as it arises.

Another property of typical embodiment of the present invention is that a letter group containing a letter in the position of the cursor has reduced ambiguity for further input using the input key for the letter in the cursor position because one of the letters of this input key is already displayed and a subsequent input event with this input key may be interpreted only with one of the other letters assigned to this key and not the displayed letter. For example, if the candidate word is “the” with the cursor at the second position of the letter “h”, then a “4” input key assigned to the letter “h” has a reduced ambiguity for a subsequent input event if an input event with the “4” input key is interpreted only as a “g” or “i” input because of the user desired the letter “h” in the cursor position, the user should accept the displayed “h” by selecting “FORWARD” rather than pressing the “4” input key.

A candidate word of an embodiment of an input guessing system of the present invention may not be the most frequent word and the cursor may be moved to any position within or after the candidate word. Rather, the “best” word and position of the cursor with respect to this best word are selected to minimize an expectation of the total number of input events needed for input of all words having the same initial input events and weighted by their frequencies. By comparison, conventional word prediction systems often propose a candidate word which is the most frequent word for a given sequence of input events and place the cursor at the position after the entered letter. For example, after the input of the first letter “r”, an embodiment of an input guessing system of the present invention may propose “really” as the candidate word and place the cursor at the third letter of the word (“a”). Conventional word prediction systems would typically propose the word “right” as the most frequent word with an initial input of “r” and place the cursor at the second position (“i”). Conventional word prediction systems may move the cursor to a forward position only if all previous letters are unambiguous. By comparison, an embodiment of an input guessing system of the present invention may move the cursor forward to any position within or after a word even if one or more previous letters are still ambiguous by using advanced word ending processing.

An embodiment of an input guessing system of the present invention typically will use advanced word ending processing to determine the best position for placing the cursor after input. If an ending of a candidate word is more expected than other possible endings, an embodiment of an input guessing system of the present invention may place the cursor at the first letter of the next word. By doing so, if the candidate word is correctly selected, and the proper ending for the candidate word is displayed, there is no need for additional input actions for accepting the candidate word, and there is no deed for input of a space separator after the candidate word. Rather, the candidate word will be accepted automatically if user continues input of the next word. For example, after the input of the first letter “y”, an embodiment of an input guessing system of the present invention may propose “you” as the candidate word and place the cursor at the position for the first letter of the next word. A user can continue input of the next word without explicit acceptance of the word “you” or needing to enter a space after “you” before inputting the next word. Using advance word ending processing can greatly decrease the amount of input and input control required by a user.

Also, if the cursor is placed within a candidate word, and the user accepts the candidate word by selecting an “OK” input or pressing an “OK” key, an embodiment of an input guessing system of the present invention may automatically add a space after the accepted candidate word because for many languages a space is the most expected symbol after a word is completed. Accordingly, the cursor may be placed at the position of the first letter of a next word. If a punctuation symbol is desired after then previous word rather than a space, an embodiment of an input guessing system of the present invention may allow a user to enter different punctuation symbols, such as a period or a comma at this moment from the cursor position for the first letter of the next word and interpret the input as needing to be placed just after the previous word.

A processing device of an embodiment of an input guessing system of the present invention may be capable of accepting and interpreting input of different languages, including syllabic and ideographic languages. Words of ideographic languages may be represented by their phonetic, simplified stroke or syllabic notation.

If an embodiment of an input guessing system of the present invention has no candidate word corresponding to the previous input, the system may guess the most possible letter or letters based on previous letters of the word. This would be the situation for entry of a non-dictionary word, and the system may try to guess one or several following letters using relative letter frequencies following already-entered letters, already-entered letter sequences (i.e., N-grams consisting of groups of N letters, such as bigrams of 2 letters, trigrams of 3 letters, etc.), and/or absolute letter frequencies for a particular language. Advantageously, the user interface may remain unchanged. Also, a system may propose to correct spelling of an entered sequence of letters.

The combined effects of the optimal selection of a candidate word and position of the cursor within or after the candidate word based on minimization of expectation of the total weighted number of input events for all words, advanced disambiguating of input events, the reduced ambiguity of a group containing a letter in a current position of the cursor, the smart processing of word endings, the advanced delimiting of words using a OK key, the automatic addition of spaces, simple error correction, the ability to generate words with embedded special accented characters by typing the key associated with the unaccented version of the letter, and the ability to automatically disambiguate among multiple punctuation characters assigned to a single key based on the context of the keystroke produces a surprising result for many languages in which an embodiment of an input guessing system of the present invention may be more efficient even for ambiguous input than unambiguous text entry with a conventional keyboard. For example, based on the statistics of the British National Corpus, the world's largest English word corpus available at http://www.natcorp.ox.ac.uk/, an embodiment of an input guessing system of the present invention may require approximately 30% fewer keystrokes using a mobile phone keypad than a conventional computer keyboard and conventional ambiguous word prediction systems. This also provides an improvement of text entry speed for mobile phones compared to conventional multitap input methods. An embodiment of an input guessing system of the present invention may require approximately a third fewer clicks than a multitap method.

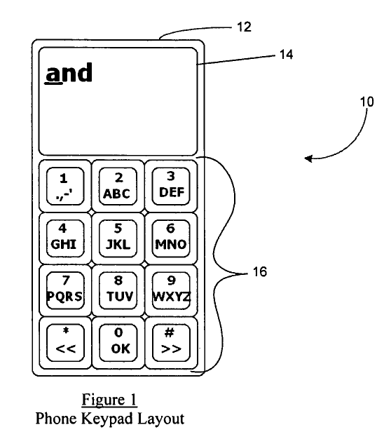

Referring now to the figures, FIG. 1 illustrates an embodiment of a standard phone layout for a user interface and data entry apparatus capable of operating in accordance with an embodiment of an input guessing system of the present invention. An example of a mobile phone 10 (or other electronic device) having an alphanumeric keypad is illustrated. The mobile phone 10 may include a housing 12, a display 14, and a keypad 16 by which input is typically received. The keypad 16 has twelve alpha keys with digits 0-9 displayed thereon in a standard layout and keys for “OK”, “<<” (BACK) and “>>” (FORWARD) operations, which may be combined with a phone d-pad, joystick, or, as shown in FIG. 1, keys bearing the symbol signs “*” (“star”) and “#” (“pound”). Also displayed in a standard layout are letters of the Latin alphabet A-Z. Letters are grouped accordingly the ITU E.161 standard, also known as ANSI T1.703-1995/1999 and ISO/IEC 9995-8:1994. These letters can be arranged in other arrangements, for example for greater ergonomic efficiency, but the illustrated layout is typically preferred on account of established use. The key bearing the digit “1” has been assigned “SPACE” and the punctuation marks like “.”, “,” and “-”.

English is used in the illustrated embodiment of FIG. 1. Alternatively, various other alphabets may be used in accordance with embodiments of the present invention, such as Greek, Cyrillic, Thai syllabic, Chinese phonetic alphabets, Japanese Kana, and Korean. In the illustrated embodiment of FIG. 1, the input device is a keypad having fewer individual keys than the number of letters in the alphabet. Therefore, the alphabet is separated into groups of letters which are represented on keys, and each key has ambiguous meaning in that selecting a key may be associated with input of more than one symbol (i.e., letter, punctuation mark, number, space, etc.).

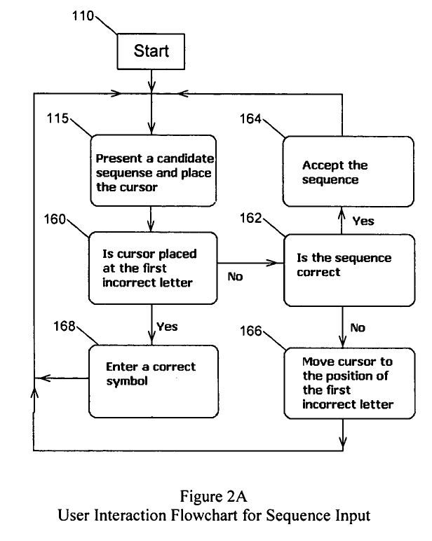

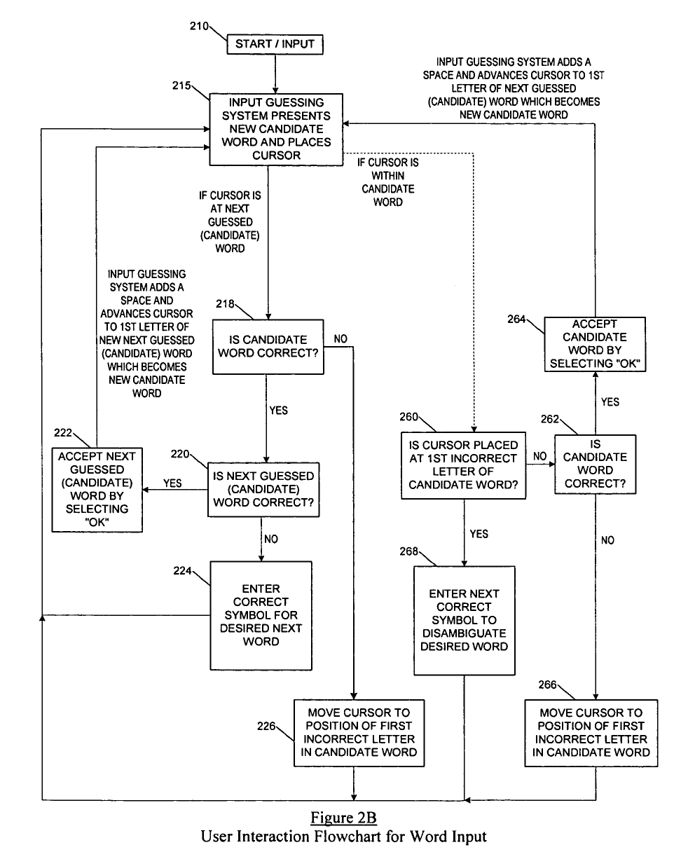

FIG. 2A is a flow diagram of a process of user interaction for an embodiment of an input guessing method of the present invention. FIG. 2A describes a general approach to an input method with consideration to sequences of input (or input sequences), rather than individual words. A sequence of input (or input sequence) for FIG. 2A refers to all letters and/or spaces generated by an input guessing method and may contain, from a user's point of view, one or more words separated by a space and/or a period and one or more spaces. For example, a sequence is any succession of inputs, such as letters, symbols, and/or spaces. Often a guessed sequence after determinate part of the sequence may involve an ambiguous stem or prefix, and a letter, symbol, or space at the cursor position followed by an ambiguous ending or suffix. A prefix or/and a suffix may be also empty. If part of the sequence includes a space, a user will perceive two words being displayed. Regardless of whether the sequence includes a space or not, an embodiment of the present invention may function by considering the entire sequence. In effect, a space delineating two words in a sequence is simply a single piece of the sequence, and the two words are merely portions of the sequence on either side of the space. As such, a cursor may be placed at any position within a candidate sequence in accordance with the present invention, although the placement may be, from a user's point of view, in a word or after a word, as described more fully with respect to FIG. 2B which describes the desired input in terms of separate words, rather than input sequences.

In FIG. 2A, starting at block 10, the input method proceeds to block 115 where the method selects the most expected candidate sequence of input, and places the cursor at the most expected position within or after the sequence. At a block 162 by way of block 160, the user checks whether the cursor is placed at the first incorrect letter of the sequence. If the cursor is placed in the position of the first incorrect letter of the sequence, the user can just continue input at block 168 by stroking a key containing a correct symbol at block 168. In addition to typical symbols which are letters, a correct symbol also may be a space or a punctuation symbol. If the cursor is at any other position (i.e., not placed in the position of the first incorrect letter), the user determines at block 162 whether the candidate sequence is the desired sequence or not. If the candidate sequence is the desired sequence, the user can press the “OK” key to accept the sequence at block 164, and the input method proceeds to the guessing of the next sequence at block 115. If the cursor is not placed at the first incorrect letter at block 160 and the candidate sequence is not the desired sequence at block 162, the user strokes a “BACKWARD” or “FORWARD” key at block 166 depending on the interposition of the cursor and the first incorrect letter in the candidate sequence. If the first incorrect letter is before (to the left of) the cursor, the user presses the “BACKWARD” key. If the first incorrect letter is after (to the right of) the cursor, the user presses the “FORWARD” key. After any user action at blocks 164, 166, and 168, the method proceeds with guessing the next candidate sequence at block 115 based on the user input.

The embodiment of the input method of FIG. 2A may alternatively be illustrated by the following user input algorithm, where the guessing system generates a guessed sequence and the cursor position. The guessing sequence contains three parts: the prefix is a part of the sequence before the cursor, the letter is the letter at the position of the cursor, and the suffix is a part of the sequence after the cursor. The prefix and/or the suffix may be empty.

```
event = NULL;
loop {
  < the guessing system generates a new guessed sequence = {prefix,
  letter, suffix} based on <event>; [block 115]
  if  ( prefix is present and is wrong ) event = BACKWARD;
  [block 160 to 162 to 166]
  else if ( letter is wrong ) event = “a correct letter”; [block 160 to 168]
  else if ( suffix is present and is wrong ) event = FORWARD;
  [block 160 to 162 to 166]
  else event = OK; [block 160 to 162 to 164]
  < user enter <event> input >
}
```

FIG. 2B is another flow diagram of a process of user interaction for an embodiment of an input guessing method of the present invention. The flow diagram of FIG. 2B differs from FIG. 2A, in that FIG. 2B is a more detailed version of FIG. 2A and accounts for desired text input of independent words, rather than input of sequences in FIG. 2A, which might be a word or may be more than a word, such as a word and a space, or a word followed by a space an another word. The flow diagram of FIG. 2B starts at block 210, typically involving initial or continuing input by a user. At block 215, the system presents a candidate input sequence, such as a word or sequence of words, and places the cursor at the most expected position within or after the candidate input sequence. If the cursor is in the candidate input sequence, the flow diagram continues to block 260, as described further below. If the cursor is at the first letter of a next guessed input sequence, the flow diagram continues to block 218. At a block 218, the user checks to see if the candidate input sequence is the desired input sequence or not. If the desired input sequence is not displayed as the candidate word, the user moves the cursor to the position of the first incorrect letter in the candidate word at block 226, as is described further below with regard to block 266. If the desired word is displayed as the candidate word, and cursor is placed in the position of first letter of the next word, no special actions are required to accept the candidate word and the flow diagram continues to block 220. If the next guessed (candidate) word is correct, the user can accept the next guessed (candidate) word at block 222 by pressing an “OK” key or otherwise selecting “OK”. The input guessing system will then understand that the candidate word was correct and the user desires to accept the candidate word, the space between the candidate word and the next guessed (candidate) word, and the next guessed (candidate) word. Accordingly the input guessing system, will then add a space and advance the cursor to the first letter of a new next guessed (candidate) word which becomes the new candidate word at step 215 and the process will then continue to block 260. Returning to block 220, if the next guessed (candidate) word is not the desired next word, the user may just continue with input of a correct symbol for the next word at block 224 and the system will return to block 215.

If the cursor at block 215 is in the candidate word, the flow diagram continues to block 260. If at block 260 the cursor is placed in the first incorrect letter of the candidate word (meaning that the candidate word is not the desired word), then the flow diagram will continue to block 268 where the user can enter the next correct symbol to disambiguate the desired word, and the flow diagram will return to block 215. This next correct symbol also may be a space or a punctuation symbol. If the displayed candidate word is the desired word, the cursor will not be placed in the first incorrect letter of the candidate word because no letters of the candidate word are incorrect, and the flow diagram will continue to 262 where the user can confirm that the candidate word is correct at block 264 by pressing an “OK” key or otherwise selecting “OK”. The input guessing system will then add a space behind the correct candidate word and advance the cursor to the first letter of a next guessed (candidate) word which becomes the new candidate word at step 215 and the process will then continue to block 260. If the displayed word is incorrect (not the desired word) and the cursor is not placed at the first incorrect letter of the candidate word, the flow diagram will progress from block 260 to block 262 to block 266 where the user can move the cursor to the position of the first incorrect letter in the candidate word. The user can stroke a “BACKWARD” (“<<”) or “FORWARD” (“>>”) key depending on positions of the cursor and the first incorrect letter in the candidate word. If the first incorrect letter is before the cursor position, the user presses “BACKWARD” key. If the first incorrect letter is after the cursor position, the user presses “FORWARD” key. After any user action, the flow diagram returns to block 215 where the system proceeds to guess the next candidate word based on the user input. The process of guessing of the current desired word continues until “OK”, or the “space” key, is pressed, or the system proceeds to place the cursor position at the first letter of a next word and the user accepts the previous candidate word by entering any key when the cursor is placed at that next word except for the “BACKWARD” key. This process may be considered simpler than interacting with conventional word prediction systems.

If a user presses the “>>” or an alpha key, all the letters of a candidate word before the current cursor position become unambiguous. In case of a user pressing the “>>” key, also the letter at the cursor position becomes unambiguous. As mentioned above, if the user inputs an alpha key, the ambiguity of the alpha key containing a letter at the cursor position is reduced when an embodiment of an input guessing system of the present invention understands that the letter at the cursor position is not desired because the user strokes an alpha key, rather than accepting the letter at the current position by pressing the “>>” key. Thus, the letter at the cursor position is not accepted by stroking the associated alpha key, but rather the input is interpreted as desiring entry of another letter associated with the stroked alpha key. For example, if the letter at the current alpha position is “j”, the user strokes the “>>” key to accept and move to the cursor position for the cursor position for the next incorrect letter following the accepted letter “j”. Alternatively, if “j” is not the desired letter for the current cursor position, and the user strokes the “5” key which has been assigned to the letters “j”, “k”, and “l”, an embodiment of an input guessing system of the present invention will understand that the user is entering further input at this cursor position to disambiguate the desired letter at this cursor position, which is not “j”, so pressing the “5” key will be interpreted only as possibly desiring a “k” or an “l” at this cursor position. Thus, the input of the “5” key is further disambiguated by the system eliminating “j” as a possibly entry at this position.

An input guessing system typically will generate a new candidate word and calculate the cursor position in the response to every user input. The candidate word and cursor position are selected to minimize the expectancy of a total number of keystrokes necessary to enter all possible words weighted by their frequencies based on previous user input.

Different algorithms for selection of the candidate word and cursor position may be used. By comparison, a conventional simple algorithm for a word prediction system selects the most frequent word having a given ambiguous beginning as the candidate word and place the cursor at the position after the first ambiguous letter. However, while such an algorithm looks logical, provides acceleration of ambiguous input, and may be used as a possible implementation of an input guessing system, such an algorithm often is not optimal, as explained further below. Other algorithms and alterations may provide further efficient improvements. The drawback of the approach of the conventional simple algorithm describe above is that it may not optimize the ambiguous input of all possible words in the dictionary, but select the optimal dictionary word for unambiguous input of only one letter. For example, the BNC contains 2,610,483 words with the first letter “r”, and 1,585,573 words starting with “re”- this is about 60% of all other “r”-words. There are 87,631 occurrences of the word “right”. It is the most frequent “r”-word, but only a small fraction of all “r”-words. The conventional simple algorithm described above, and used in many conventional word prediction systems, proposes the word “right” as the candidate word and will place the cursor at the second letter. So, for all other “r”-words, a user will be forced to enter a second letter for these words. By comparison, consider the candidate word “really” (the most frequent “re”-word) and place the cursor at the third position. In this case, for about 60% of “r”-words starting with “re” a user does not need to enter the second letter “e”, and for the remaining 40%, a user needs to enter a backward command “<<” and a second letter. Therefore, to enter a second letter of all “r”-words for the simple algorithm a user has to make an additional input 100% of the time (60%*1 input+40%*1 input=100% of inputs), but for the second method a user only has to make an additional input 80% of the time (60%*0 inputs+40%*2 inputs=80% of inputs). The second method provides an improvement of 20% compared to the convention simple algorithm for the selection of the most frequent word as a candidate word and cursor position of a word prediction system.

Another reason of for the non-optimal behavior of the simple algorithm is ambiguity of input. For example, the most often “w”-word is “was”, but the most frequent “wi”-word, “with”, is a better candidate word following an initial “w” input because “i” shares the key “4” with “h”, which is another frequent after-“w” letter. So to enter any “wh”-word using the simple algorithm, after entering a “w”, a user needs to press “4” which will result in the most frequent word “with” being displayed as the candidate word and then “<<” to convert “i” to “h”. But using an alternate method described above where further input with the key associated with the letter at the current cursor position, after inputting “w”, the system selects “with” as the best candidate word rather than “was” (the most frequent word) and places the cursor at the “i” position. The user then can just press “4” to change from “wi-” to “wh-”. The system can determine that further input of “4” does not desire “i”, but indicates input for “h” or “g”. with “wh-” being more frequent than “wg-”, the system will select a “wh”-word for the next candidate word. This can decrease keystrokes by more than 20% for input of a second letter for “w”-words compared to the simple algorithm which relies upon the selection of the most frequent word. Thus, embodiments of the present invention advantageously account for ambiguity of input for the selection of the best candidate word.

An important features of the present invention is the possibility that the cursor may be moved more than one position forward and up to two positions forward after the candidate word (where a space is added after the candidate word) to the initial letter of a next word even if letters to left of the cursor position are still ambiguous. Other word prediction systems forward the cursor only to the position immediately following the last unambiguous letter.

In the case when the cursor is placed at the second position after the candidate word (where a space is added after the candidate word and the system places the cursor at the position of the first letter of a next guessed candidate word), an embodiment of the present invention does not require input of an “OK” or “space” to complete the entry of the candidate word. Instead, a user may continue with the input of the next word and the system will understand this continued input as acceptance of the previous candidate word. This feature is described herein by the term “advanced word delimiting.” Such advanced word delimiting provides further reduction of keystrokes.

In some cases, a cursor also may be moved one or more positions backward within an ambiguous part of a word. Usually, the position of the cursor with respect to the candidate word is the position in which the expectancy of change is maximal, so it is expected that a user will change the candidate word at this position. Each user input changes the candidate word and the cursor position.

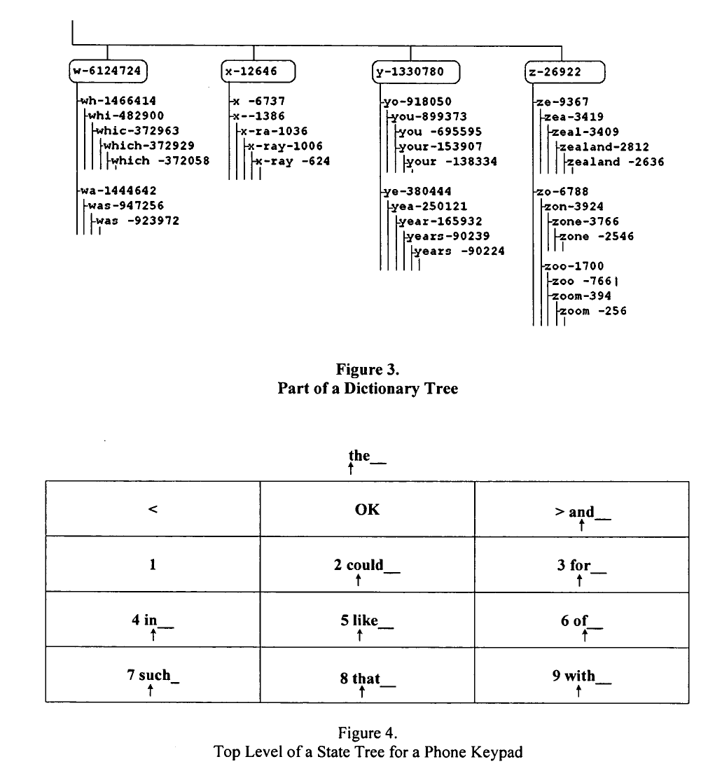

Generally, a dictionary tree with word and word stems frequency information, information on all input events, and candidate words displayed earlier is needed to select the best candidate word and cursor position. FIG. 3 presents a part of such a word/stems frequency tree for letters assigned to key “9” for English in accordance with an embodiment of an input guessing system of the present invention.

Description of example data structures and processing algorithms which may be used with an embodiment of an input guessing system of the present invention is presented below with respect to additional description of embodiments of the present invention.

The dynamic selection of the best candidate word may be based on analysis of input of all possible words and may be a computationally intense problem. To reduce these computational costs (and high processing demands), embodiments of an input guessing system may be constrained to consider only a limited number of levels of recursion. Such an approach requires fewer computations (and less processing resources), but may provides results which are still close to an analysis of the whole word corpus.

To provide further explanation of possible input and processing algorithms which operate in accordance with the present invention, the process of input for the word “zoom” in the context of the BNC is described below for an example input guessing method. The letter “z” typically shares an assignment to the key “9” with the letters “w”, “y”, and “x”. The BNC contains 6,069,521 words beginning with “w”, 1,329,693 words beginning with “y”, 27,045 words beginning with “z”, and 13,286 words beginning with “x”. Therefore, the most expected first letter from input of a “9” keystroke is “w”, and the first “best” candidate word may be “with” and the cursor may be placed at the second letter (“i”). This “best” candidate word selection and cursor position is determined because although “with” is the most frequent “wi”-word, more than a half of the 6,069,521 words beginning with “w” have a second letter different then “i”. Because a “w”-word (such as “with”) is not the desired word (“zoom”), the user presses “<<” to indicate that the user desires a different first letter from the “9” keystroke.

The next most expected first letter is “y”. The new “best” candidate word (if not “with”) is “you”, and the position of the cursor is at the second position after the word “you” (and an added space), because the BNC has 695,595 words beginning with “you”. This is more then 50% of all words beginning with “y”, so the most expected user action for the word “you” is an input of the first letter of a next word. Because the desired word (“zoom”) is not “you”, the user presses “<<” key to correct ambiguous letters.

In this situation all of the letters of the candidate word “you” are ambiguous. However, even if the desired word is not “you”, there still remain 634,098 words in the BNC with the first letter “y”. This is more than the number of all words with the first letter “z” or “x”, so the most expected first letter is still “y”, and the new “best” candidate word (if not “with” or “you”) will still begin with “y”. The second expected letter is now “e”, because the BNC contains 379,062 words beginning with “ye-”, and “ye-” now is the most frequent beginning for words with the first letter “y” if not “yo-”. So, the new candidate word is “years”. The optimal cursor position is the second position (letter “e”), because this is the position with the greatest expectancy of changes. This is still not the desired word (“zoom”), so the user presses “<<” again.

Now the first letter changes to “z”, the most expected word is “Zealand”, and the position of the cursor is at the second letter “e”. “Zealand” is not the desired word (“zoom”), but the cursor is located at the position of the first incorrect letter, so the user can press the “6” key assigned to the letters “m”, “n”, and “o” to begin input to disambiguate the second letter for the desired word. From the letters “m”, “n”, and “o”, the most expected second letter after a word beginning with “z-” is “o”. The new candidate word is “zone”, and the position of the cursor is at the third letter (“n”). Note that now the first letter (“z”) of the candidate word becomes unambiguous because the user has begun input for disambiguating the second letter of the word input.

“Zone” is still not the desired word (“zoom”), but the cursor is located at the position of the first incorrect letter (“n”), so the user can press the “6” key assigned to the letters “m”, “n”, and “o” again. Note, that now the ambiguity of the “6” key is reduced. The letter “n” is excluded from consideration, because it is already at the cursor position which the user identifies as being incorrect when entering additional alpha input at that cursor position, so only the letters “m” and “o” remain as possible inputs. From these two letters the most expected letter after a word beginning with “zo-” is “o”, the candidate word is “zoological”, and the position of the cursor is at the first letter “1”.

The user can press the “6” key again to input “m”, even though the input is ambiguous as possibly representing “m”, “n”, or “o”. The candidate word will become “zoom”, and the cursor is placed at the second position after the word (at the first position of a next guessed word following a space added after “zoom”). So, the desired word is entered and the user is ready to input the next word.

Therefore, the user has entered the following sequence containing 7 keys: “9”, “<<”, “<<”, “<<”, “6”, “6”, and “6” to unambiguously input the word “zoom”. The word “zoom” was selected for this example because it is a rare word and provides the ability to demonstrate different aspects of the present invention. But even to enter the rare word “zoom”, the described input guessing method needs only two clicks more than the 5 clicks necessary to enter “zoom” using a regular keyboard, but much less than the 12 clicks necessary to enter “zoom” using typical phone multitap input. The number of clicks for other intermediate candidate words presented during this process are: “with”—2 for the input guessing method, 5 for a regular keyboard, 12 for multitap; “you”—2 for the input guessing method, 4 for a regular keyboard, 9 for multitap; “years”—4 for the input guessing method, 6 for a regular keyboard, 14 for multitap; “Zealand”—5 for the input guessing method, 8 for a regular keyboard, 15 for multitap; “zone”—6 for the input guessing method, 5 for a regular keyboard, 12 for multitap; and “zoological”—7 for the input guessing method, 11 for a regular keyboard, 26 for multitap.

So, in many and often in most cases, the input guessing method is more optimal than keyboard input and several times more optimal than conventional phone multitap input. For the whole word set of the BNC, the input guessing method requires approximately 30% fewer keystrokes than a regular keyboard, and approximately 3 times fewer keystrokes than conventional phone multitap input. And most frequently used words are entered in 2 or 3 keystrokes using the input guessing method.

An embodiment of an input guessing system, method, or computer program product of the present invention may store information about word frequencies in the form of a dictionary tree and dynamically calculate candidate words and cursor positions. The dynamic selection of candidate words and cursor positions is necessary if assignment of letters to ambiguous sets may be changed dynamically. For example, for miniature keyboards at one moment both the “s” and “d” keys may be actuated simultaneously to create one ambiguous group, at another moment both the “a” and “s” keys may be actuated simultaneously, etc.

If the ambiguous assignment of letters to keys is static, as shown in FIG. 1, the processing algorithm and data structures may be simplified further. The dictionary tree may be converted into a state tree in which every node represents a system state (a candidate word and the cursor position for this word) and every branch represents an input event. If a branch with input event E comes from node A to B, that means that the input guessing system switches its state from A to B in case of input E. With such a state tree, the processing algorithm may become trivial: to get a new state (a candidate word and a cursor position) the input guessing system just selects a link corresponding to current input event from the current node of the state tree.

A state tree may be generated from a dictionary tree to minimize an expectancy of the total number of input events for all words in the dictionary taking in account word frequencies. Conversion of the word tree into the optimal state tree may be implemented as a recursive process of joining of sets of optimal subtrees for different word stems using above described algorithm. This process may be time consuming, but is only necessary to execute once.

FIG. 4 illustrates an embodiment of the top level of such a state tree for English based on BNC statistics for a phone keypad. The candidate input sequence “the” followed by a space may be displayed before any input by a user. The position for the cursor in the resulting candidate word “the” followed by a space is indicated by a small arrow placed beneath the position of the letter “t”. Note that the state tree may not store unambiguous parts of words in nodes, because unambiguous parts of words can be reconstructed from upper levels of the state tree, so nodes of a state tree may contain only ambiguous parts of words. Selecting a fixed form of a tree also may not need to store branch events. By using a state tree, frequency information does not need to be stored. These improvements to typical state tree data structures radically reduces the memory requirements for an embodiment of an input guessing system of the present invention and permit its use with memory-limited devices. Also, if memory requirements are known in advance, a dictionary of words and a state tree may be reduced to remove the least frequent words to meet memory limitations.

The “<<” operation always changes an ambiguous letter to the left of the cursor. But if the cursor is already positioned at the first ambiguous letter, then an input guessing system may interpret “<<” operations as “UNDO” operations and return to previous states of guessing process. Such an UNDO process may be equivalent to moving up the state tree. For example, if a user presses “<<” several times during entry of the word “zoom”, the system may return to previous candidate words: “zone”, “Zealand”, etc. So if a user made a mistake during input, then the user may be able to return to one of the previous states and continue a correct input from this previous state. This input error correction algorithm may advantageously be used with embodiments of the present invention.

As mentioned above, each “>>” or alpha input makes the letters to left of the cursor unambiguous. These unambiguous letters will not be changed during further input. Such behavior of an input guessing system makes the displayed word less “jumpy” and less likely to confuse a user.

An embodiment of the present invention may also provide a simple way to input different punctuation marks. For example, punctuation marks may share the same key assignment as the SPACE symbol. If a user strokes this key when the cursor is placed at the first position of a word, the most probable input is not a SPACE, but punctuation marks in the following order: period, comma, and then other marks. Punctuation marks may be added at the position immediately after the previous word and a following space may also be added. The cursor may then be placed at the position of the first letter of the next guessed word.

In addition, for example, the SPACE symbol may be combined with an “OK” command and share the same input key. In this case that a SPACE is entered and there exists a dictionary word having a space in this position, then this word is considered as a desired word and the cursor is placed at the first letter of the next word. In the case where a SPACE is entered but there does not exist a dictionary word having a space at this position, SPACE input may have the same effect as “OK”, and the current candidate word is accepted as described above. Combining the SPACE and OK on the same input key may slightly decrease input efficiency, but reduces the number of necessary unambiguous keys, and may provide an easier or more intuitive interface for some users.

An embodiment of the present invention may be even more efficient if it use additional information about language. For example, if information about frequencies of word pairs is known, a processing algorithm may propose as the initial candidate a word following a previous word based on the knowledge of the previous word and the most possible word pairing for a candidate word following the previous word. Such information may be stored for a limited number of the most frequent words (e.g., several thousands) to limit the required memory space. Another kind of language information which may be useful for further acceleration is information about possible combinations of parts of speech. For example, in English, two articles normally will not be found one after another and a verb is the most expected part of speech after the word “to”. Such language information typically will not require a lot of memory and/or change user interface, but it can make guessing an initial word more successful, even though it may require additional and/or more sophisticated internal processing.

Input device layouts other than the standard phone keypad layout may be used to reduce the number of keystrokes needed for a particular input guessing algorithm. For example, the key “2” of a standard phone keypad layout is used much more frequently then key “5”. It may be useful to make symbol-keystroke assignments more balanced based on letter frequencies. Such layouts can be calculated, for example, using optimization methods of functions of multiple variables using the total number of keystrokes for the given dictionary as the target function. Such layouts may improve efficiency of guessing, but will initially require additional user effort to memorize the layout.

As mentioned above, embodiments of the present invention may be easily adapted and used for different languages. In case of languages based on the Latin alphabet, all additional accented characters may share the same keys as their regular letter forms and be considered in the same way as regular letter forms for input guessing. For other alphabet-based languages, embodiments of the present invention may use keypad layouts which are standardized for these languages, or layouts which are optimized for these languages to operate in accordance with an embodiment of the present invention. Word selection for alphabet-based languages may be based on information on these keypad layouts and word frequencies for a specific language. Processing algorithms and user interaction interface for alphabet-based languages may be the same as described above for English. Some changes are necessary for adapting some of the above described embodiments of the present invention for right-to-left languages like Hebrew, or languages with position-dependent symbols like Arabic. These changes generally are related to visualization of input, and are not related to the input guessing.

Embodiments of the present invention may also be used for non-letter based languages, such as syllabic and ideographic languages, like Indic, Thai, Chinese, Korean, Japanese, etc. For use with non-letter based languages, basic word components may be mapped onto a keypad.

For syllabic languages, keypad mapping may be done by mapping syllables onto keys based on their consonant. Derivative syllables may share the same keys as their basic forms, similar to described above for accented letters of the Latin alphabet and preferably be disambiguated using an indexing method described below. In some syllabic languages, for example in Thai, the input of a SPACE symbol is not needed for word delimiting. An embodiment of an input guessing system may be adapted for such language-specific requirements, such as to not add a SPACE after a Thai word as it is completed.

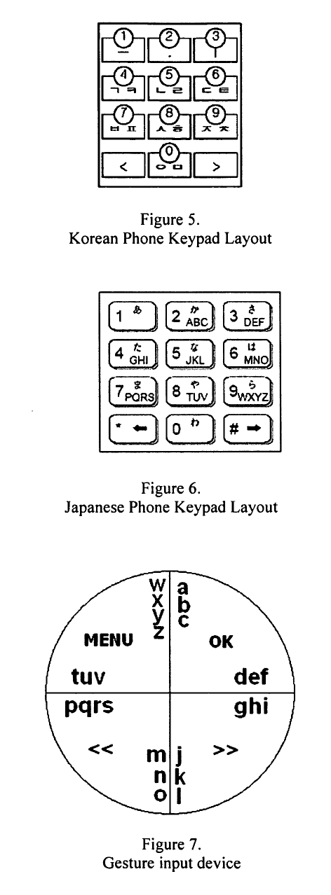

Korean Hangul symbols may be decomposed into basic consonant and vowel jamos which may be grouped and mapped onto a phone keypad, as shown in FIG. 5. Because a structure for Korean symbols is well defined, the above described methods can be used with minimal changes related to the more complex visualization of the cursor position. An individual jamo in the position of the cursor may be differentiated from other jamos of a symbol, such as by highlighting that jamo.

For Chinese and Japanese languages, an existing phonetic alphabet may be used for decomposition of words. The elements of phonetic alphabets may be assigned to a phone keypad using basic Latin alphabets, or in some other way utilizing the structure of a phonetic alphabet. For example, Japanese Kana symbols may be used for input of Kanji words. Kana symbols may be represented by pairs of Latin letters in Romaji notation, or individual Kana syllables may be mapped to keys of a phone keypad based on their consonants, as shown in FIG. 6, similar to the way mapping may be done for syllabic languages and preferably be disambiguated using an indexing method. In the first case, a regular Latin phone keypad layout may be used; in the second case, a grouping based on Kana symbols may be used. This grouping also may be created using word/symbol frequency information for the Japanese language. An input guessing system may present a candidate word to the user in Kana form, which may later be converted into Kana-Kanji presentation, if necessary.

For the Chinese language, either BoPoMoFo or Pinyin, based on the Latin alphabet, may be used. BoPoMoFo symbols may be processed in the same way as Kana symbols. A regular Latin phone keypad layout may be used to input letters of Pinyin elements, or specific Pinyin layout may be made for tones, initials, and finals corresponding to structure of Pinyin input. Keys of these layouts may contain groups of initial and final sounds. This manner of grouping may be created using existing subdivision of Chinese sounds into phonetic groups. This approach may accelerate the input of Chinese words compared to use of a Latin keyboard layout.

In some cases there may be two representations of a word: phonetic and ideographic. Since embodiments of input guessing methods may work with a phonetic representation of a word, an additional display area may be used to show the basic phonetic components of a word and the cursor placement. This additional display area may use a small fraction of a primary display screen, but will provide additional visual feedback for the user.

Another way to input ideographic words is stroke-based input. Strokes of Chinese symbols may be classified into eight basic classes, which may be assigned to keys of the phone keyboard. The order of strokes in each word is predetermined. Input guessing of an embodiment of the present may be applied to ambiguous stroke input for Chinese words. A secondary display area may be used to visualize and change sequences of strokes.

For inputs with many basic meanings assigned to every input event, the ambiguity resolution of each event may be preferred instead of using a BACKWARD command at the event level. For example, after every input event, a method of per-event ambiguity resolution may be used to resolve event ambiguity before proceeding. The input will then be considered as unambiguous for the main input guessing algorithms because ambiguity was resolved at the event level. Partial ambiguity resolution may be performed at event level to reduce the number of ambiguous meanings for main input guessing algorithm, and to increase the speed of the input guessing algorithm.

Embodiments of input guessing systems, methods, and computer program products of the present invention may be adapted for different applications and to different contexts. Embodiments of the present invention may be used, not only with conventional words, but also with other types of text input of non-conventions words, such as phone numbers, abbreviations, identifications, inventory records, medical terms, etc. In general, embodiments of the present invention may work with any sequences of input events with assigned meanings, including, but not limited to, characters, signs, strokes, gestures, and sounds, and such sequences of input events may be specific to an application or context. Each application may have its' own dictionary of sequences with frequency information. These dictionaries may be dynamic and adapted to a particular user's style of writing and frequency dictionary. New words may be added to a dictionary, and frequencies of existing and new words may be changed during an input accordingly word usage specific to an individual user.

As mentioned above, embodiments of the present invention may be applied, not only to keypad input, but to any sequences of input. One popular method of input is handwriting input. The ambiguity of entered symbols may be created for many different reasons, such as individual styles of handwriting, closed shapes of letters, simplified handwriting processing algorithms, etc. If the handwriting input is combined with an embodiment of the present invention, a plurality of meanings may be assigned to each inputted symbol and handwriting input may be corrected and/or accelerated by input guessing.

Embodiments of the present invention may be applied to gesture input of any nature, when several meanings may be assigned to a limited number of basic gestures (e.g., assigning all planar strokes to a limited set of 8 directions, all 3D motions to a limited set of 6 vector directions, etc.). Then input objects may be used to enter input using sequences of these gestures. Any methods and/or hardware may be used to input gestures, such as using a joystick, d-pad, pen, stylus, accelerometer, gyroscope, camera, etc. Gestures may be recognized using any of, but not limited to, video, electro, touch, and motion processing. Even hand or face gestures could be used for recognition and input. Ambiguous input of simple gestures may be useful for input by persons with disabilities or for input in constrained conditions, such as when driving a car or scuba diving, when use of other input methods, such as typing on a keyboard, is difficult, prohibitive, unavailable, or impossible.

An example of a miniature gesture input device having only 4 sensitive elements arranged as a dial is presented in FIG. 7 and described in U.S. Provisional Patent Application No. 60/581,064, entitled “Stroke-Based Data Entry System and Method” and filed Jun. 18, 2004, and in a corresponding International Patent Application filed under the Paris Convention Treaty, entitled “Stroke-Based Data Entry Device, System, and Method” and filed Jun. 16, 2005, which are incorporated herein by reference in their entireties. This device may be capable of inputting letters of any alphabet in both ambiguous or/and unambiguous manners by recognition of sequences of input elements. Clicks (selections or other user interaction) at one of the four input elements may be interpreted as “OK”, “BACKWARD,” and “FORWARD” commands and switching to a menu mode in accordance with the present invention. Therefore, such a miniature gesture input device may be capable of providing input guessing according to an embodiment of the present invention.

Ambiguity of input of a miniature keyboard may be caused by mutual actuations of two or more adjacent keys. This can occur often, particularly for certain users, and usually is resolved by analysis of the sequences in which the keys were pressed. Unfortunately, the sequence in which multiple keys were pressed does not result in correct input in most cases and often leads to input mistakes. To prevent such mistakes, a user typically tends to try and press keys more accurately, which usually slows down the user's input speed and reduces the ergonomics of miniature keyboards.

Embodiments of the present invention may be applied for resolution of ambiguity of miniature keyboards. If several keys are pressed simultaneously, an input guessing system may consider all of the words containing any of these letters, essentially forming an ambiguous input group from all the simultaneously pressed keys, and may select a candidate word based on dynamic analysis of language information from a word tree. If the input guessing system proposes a correct letter, the user can continue input as described above. If the guessed symbol for the candidate word is not the desired input, the user can press the “BACKWARD” key, and the input guessing system may proposes a new candidate word containing another of simultaneously entered symbols. For example, if 2 keys “t” and “r” were pressed simultaneously at the first position of the word, then an input guessing system may first proposes the word “the”. If this word is rejected, the input guessing system will then propose the word “really”. If only one key is pressed, then the input is unambiguous, and an input guessing system will proposed the best candidate word for this letter.

As mentioned above, an embodiment of an input guessing system of the present invention may be used with an unambiguous keyboard. In this case the processing algorithm may be simpler than using an ambiguous keyboard, but other user interaction interfaces may remain unchanged. Due to the unambiguity of the keyboard, a user may only use a “BACKWARD” command for correction because a “FORWARD” operation may be represented by the input of a letter which is the same as a letter in the current cursor position. “OK” may be combined with “SPACE”, as described above. Therefore, if the “BACKWARD” correction command is combined with the “backspace” key, then an input guessing system may use keys of a regular computer keyboard without any changes or any additional buttons. Unambiguity of input events reduces an expected number of clicks per symbol. Use of an embodiment of an input guessing system of the present invention with an unambiguous keyboard may reduce required keystrokes by approximately 40% over conventional use of a regular (full QWERTY) keyboard input.

There is little difference between efficiencies of embodiments of input guessing systems of the present invention used with a regular keyboard and a phone keypad. One reason for this is that usually only the first 2 letters of a word require more then one keystroke using a phone keypad, and most other letters are usually correctly entered with only one keystroke when using an embodiment of the present invention which is just like using an unambiguous keyboard.

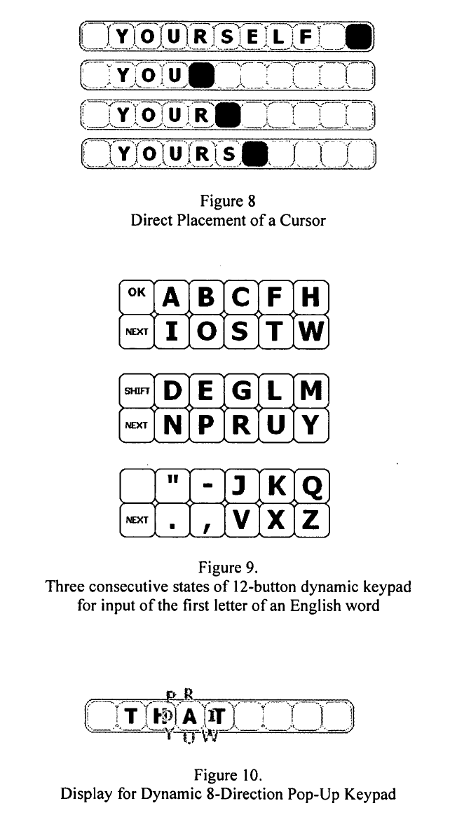

For embodiments of the present invention with touch screens, a user may make a manual placement of the cursor into the position of the first incorrect symbol. Therefore, the system would not need special “<<” and “>>” keys for adjustments of the cursor position with respect to the first incorrect symbol and a special “OK” key for word acceptance. The candidate word may be accepted, if the user places the cursor at the second position after the word. As for key-based input, an input guessing system with a touch screen generates a candidate word and place the cursor. If the cursor position coincides with the first incorrect letter, the user can enter a correct letter. If the cursor and first incorrect letter positions are different, then the user can direct manual placement of the cursor, such as directly points at the position of the first incorrect letter using a stylus. Then the system guesses a most expected letter in this position, and, if necessary, the user may enter a correct letter. The candidate word in this case may be selected using different criteria. The most expected word may be selected counting frequencies of stems of this word being words themselves. For example, for the first letter “y” the candidate word may be “yourself” combining words “you”, “your”, “yours” and “yourself”, as shown at FIG. 8. The cursor is placed at fourth letter (“r”). To enter “you”, the user can touch a stylus at the position of the letter “r” to indicate this position as the position of the first incorrect symbol, and the system will change this letter to a most expected symbol, which is a space, and the word “you” is then entered and may be accepted by the user entering or touching the next desired symbol. Similarly, to enter “your”, the user can touch a stylus at the position of the letter “s”, the system will change this letter to a space, and the word “your” is then entered and may be accepted by the user entering or touching the next desired symbol. Again, similarly, to enter “yours”, the user can touch a stylus at the position of the letter “e”, the system will change this letter to a space, and the word “yours” is then entered and may be accepted by the use entering or touching the next desired symbol. To enter and accept “yourself” as the desired input sequence, the user can just touch a stylus at the second position after the word “yourself” or otherwise entering the next desired symbol.

Increased acceleration of input may be achieved using dynamic predictive keypads with limited number of buttons. Such dynamic predictive keypads may be implemented by software as on-screen keypads or using HW buttons with dynamically changeable legends. At any moment of input only a limited number of the “most expected at this moment” commands, symbols or input events may be displayed unambiguously on such a keypad. For example, FIG. 9 demonstrates three consecutive states of an embodiment of a dynamic predictive English 12-button keypad for the input of the first letter in a word operating in accordance with an embodiment of the present invention. Such a keypad may always have a key for the “NEXT” command, which may change the layout of a dynamic keypad to the next layout state. A combination of input guessing of the present invention and a predictive dynamic keypad may provided further input acceleration. Usually only input of the first letter may require switching to a next layout. Other letters usually are entered using just the initial layout, and do not require the user using the NEXT command.

Another improvement, or an alternative feature, to improve overall input speed is a combination of input guessing of the present invention, a touch screen, and a dynamic pop-up gesture keypad, as shown in FIG. 10 for an 8-directional gesture input device. Such an arrangements works like touch-screen embodiments described above, but input events for the additional small pop-up directional keypad appear at the position of the cursor, or the cursor position identified by the stylus. The additional input events contain 8 letters corresponding to the 8 directions of the 8-directional gesture input device. These letters are generated dynamically and may be the 8 most expected letters for the state. A pop-up letter may be entered by stroking the directional gesture input device in the direction of the desired letter. In the depicted embodiment, cursor placement is combined with letter input in one simple stroke gesture, instead of two separated sequential clicks for cursor placement and letter input using a keyboard or keypad.

One of ordinary skill in the art will recognize that the present invention may be incorporated into hardware and software systems and subsystems for data entry devices. In these devices of the data entry systems, the device or system generally may include a computer system including one or more processors that are capable of operating under software control to provide the data entry of the present invention.

Computer program instructions may be loaded onto a computer or other programmable apparatus to produce a machine, such that the instructions which execute on the computer or other programmable apparatus together with associated hardware create means for implementing the functions of the present invention. These computer program instructions may also be stored in a computer-readable memory that can direct a computer or other programmable apparatus to function in a particular manner, such that the instructions stored in the computer-readable memory together with associated hardware produce an article of manufacture including instruction means which implement the functions of the present invention. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the present invention. It will also be understood that functions of the present invention can be implemented by special purpose hardware-based computer systems which perform the specified functions or steps, or combinations of special purpose hardware and computer instructions.

Embodiments of the present invention are not limited to input of the disclosed example information types, but rather, embodiments of the present invention may be applied for optimization of the access process to information of any type if statistics for the used information type are known, and therefore, can be applied for using with an input system, method, or computer program product in accordance with the present invention. Many types of information and objects are stored or associated in a hierarchical form which allows a user to access the information and objects by navigating through an access tree. A tree structure and the user interface may be optimized by an embodiment of the present invention to provide faster and/or more efficient access to the “more valuable” information and objects. For example, in the Windows Start menu, a user can access from different directories “most recent documents” and frequent programs which are deemed “important” in Microsoft's point of view or based on usage and according to Microsoft's default algorithms to establish importance and/or usage frequency. This structure is basically a hierarchical tree and the lists of information or objects (applications, documents, websites, etc.) are lists for predicted actions. If a user clicks on the “All Programs” or “Programs” directory (depending upon the version of Microsoft Windows the user is operating), the user will arrive at the next level in the tree structure, if the user then clicks on the “Microsoft Office” directory which is typically found at the All Programs level, the user will arrive at the next level in the tree structure, and so on. The access tree may be customized for each user using access statistics for that user to provide faster access to the user's favorite applications, documents, websites, etc. So, for example, when the user clicks on the “All Programs” directory, access to the user's favorite game may be shown and/or pre-selected immediately, and without requiring the user to search through the current list for the link to the user's favorite game. A similar procedure may be applied to the “favorite” pages of web sites with sophisticated structure, online data bases, etc.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### Additional Description of Embodiments of the Present Invention

The following provides description of embodiments of the present invention, including further details of the embodiments described above and additional description of potentially more generic and/or expansive uses of the present invention, including description of example data structures and processing algorithms which may be used with an embodiment of an input guessing system, method, or computer program product of the present invention.

Unambiguous Input

Input is unambiguous if each input event has the only one meaning representing a character. The typical example is regular keyboard input.

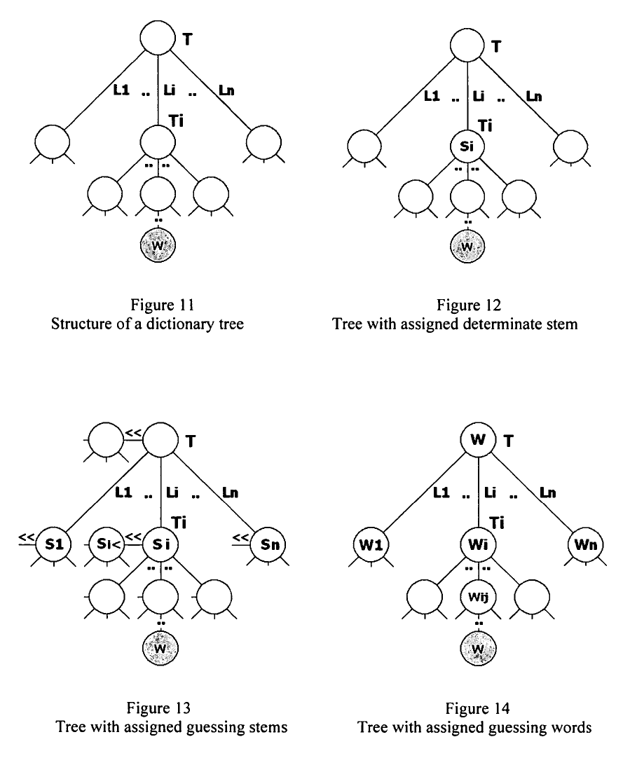

Let's consider unambiguous input and the corresponding input or dictionary tree T (FIG. 11) for a language. The top node corresponds to the empty initial state and stem. Each link of this tree connects the parent node and child node and corresponds to a possible input event (symbol Li) after the parent stem. Terminal nodes W correspond to words of a language. Let's call as the valence V of a node N the number of input events possible after this node (number of links from this node N in T). The valence of the terminal nodes is equal to zero (0). This tree T represents statistical information for a language and is build from a large, representative corpus of words for this language.

We know the number of occurrences NW of a word W in a language corpus and the depth DW of every terminal word W in this tree, where the depth DW is the number of input events necessary to enter a word (also referred to as the length+1 of the word). Then the total number MW of input events (keystrokes) to input all occurrences of a word W in a language corpus is equal NW*DW. The total number of input events M to enter all words of a language corpus is equal to SUM(NW*DW).

For example, this number M is equal to the number of keystrokes necessary to enter the entire language corpus at a regular QWERTY keyboard. The efficiency of the input process corresponding to this input tree may be estimated as I keystroke per character (kspc). Let's study now what can be done to reduce the number M and to improve the efficiency of input. Let's also designate as the weight NT of T−the sum SUM(NW) for all words in T.

Determinate Stems

Let's designate as S a possible sequence of input events in the input tree T. Each S corresponds to some stem of a word. At first, we may remove all determinate stems Si in T and include them into the corresponding children nodes. A sequence Si connecting nodes N1 and N2 is determinate if all inner nodes in this sequence have valence 1. Therefore, the first event Li in this sequence determines the whole stem Si. Then we can preserve only the first link Li of Si in the tree, and assign the remainder of Si to the node after Li (FIG. 12). In other words stem S after N1 uniquely determines N2.

Now, if we enter Li after N1 the whole sequence Si will be entered by input system. This is a very logical solution and is used in some existing word prediction system. It may save a lot keystrokes in the ends of words, because very often words have unique endings and we can enter the whole ending by its first letter only. Also let's note that now all non-terminal nodes of T have valence 2 or more.

The number of keystrokes M′ for the new tree is equal to M−DSi*NTi, where NTi is weight of Ti and DSi is the depth of Si. The depth of Si is the number of keystrokes we need to enter to reach Ti form the root of T. Then for each word in Ti, we need DSi less keystrokes to enter each word, because these DSi characters will be entered automatically by the input system.

One of the important cases of determinate stems are terminal dangling words. If we have such a situation, then by assigning their stems to upper nodes, the input system may make word completion without waiting of input of the whole word.

Let's suppose that we made assignment of determinate stems for all nodes of T and restructured the tree accordingly. Now, the valence of any node is 2 or more and dangling stems of terminal words are assigned to terminal nodes.

Guessing Stems

We propose to make another step and to assign a guessing stems to nodes of T. The difference of a guessing stem to a determinate stem is that if we reach a node N and displayed a determinate stem in a node N we can continue input with 100% probability, but for a guessing stem that probability may be less then 100% and in some cases after the system displays the guessing stem, the user may reject it by pressing a BACKWARD (or <<) key. If the stem is rejected we remove it and continue input for all non-stem words. If the stem is not rejected, then the guessing stem is added to the input sequence and input is continued after this stem for all words containing this stem. The structure of the tree is illustrated at FIG. 13.

We have a new possible event BACKWARD (or <<) in every node. The guessing stem may be absent. Let's study what stems of T may be assigned to each node of T as a guessing stem in order to reduce total value of M.

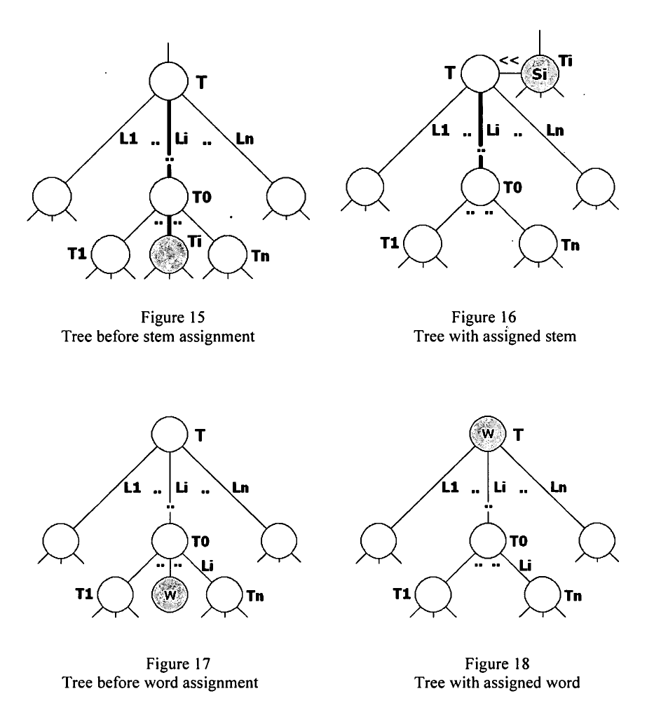

The initial structure of T is illustrated at FIG. 15.

We want to assign the stem Si between nodes T and Ti to a root node T. The number of input events in the T is equal to MT/Ti+MTi+DSi*NTi, where MTi is the number of input events in Ti, MT/Ti is the number of input events in T excluding all words in Ti, DSi is the depth of the stem Si (the number of keystrokes necessary to enter for descending to Ti from T), and NTi is the weight of all words in Ti.

After the assignment of the stem Si to the root node the structure of the tree T′ will be as at the FIG. 16.

The number of input events in the new tree T′ is equal to MT/Ti+MTi+NT/Ti, where, and NT/Ti is the weight of T excluding all words in Ti. This expression means that building T′, we reduced a number of necessary keystrokes for each word in Ti by DSi, but increase a number of necessary keystrokes for each word in T/Ti by 1, because we need to reject Si before processing to input of words in T/Ti.

The second tree T′ may have a bit different structure if the valence of T0 is 2. In this case after removal Ti the valence of T0 becomes equal to 1 and we have determinate stem corresponding T1. The size of the T′ in this case is additionally reduced by NT1. So finally, the number of keystrokes M′ in T′ is equal to MTi+MT/Ti+NT/Ti−NTi′, where NTi′ is equal to 0, if valence of T0 is more then 2, and to weight NT1 of the sibling node, if the valence of T0 is 2.

The second tree T′ requires less keystrokes if:
(MTi+MT/Ti)+(NT/Ti−NTi′)<(MTi+MT/Ti)+DSi*NTi, or
DSi*NTi+NTi′−NT/Ti>0

Let's note, that NT/Ti=N−NTi, where N is the weight of the whole initial tree T. Then above condition transforms to
dS=(DSi+1)*NTi+NTi′″N>0 (1) or
(DSi+1)*NTi+NTi′>N (2)

So, to find the best guessing stem we should find a subtree Ti for which dSi is positive and reaches the maximum dSi for available subtrees Ti for which dSi is positive. Si is the stem connecting the root of T and Ti.

If there are no such stem we preserve the structure of T and do not assign any guessing stem to the root node. If such stem exists then we change a structure of T to T′ and assign the best guessing stem Si to the root node T′. Now we can execute the same process of selection of the best guessing stems for root nodes of all subtrees of T′. We continue this process for all branches till we reach the terminal nodes.

Let's consider in details the process of the selection of the best guessing stem Si for a tree T.

At first, let's consider stems having the depth 1. The above condition becomes
2*NTi+NTi′>N (3)

There may be 2 situations of valence of the root node of T′.

The root node has the valence 2, then condition (3) is valid for any of two possible stem Si, because N=NTi+NTi′. So we need to find which of these two stems has a maximal NTi and consider it as the best guessing stem of length 1. If there is no stems longer then this, then it is the overall best guessing stem. This situation is realized when T′ contains only two words. Then NTi=NWi, and two only possible stems have depth 1 and coincide with words. So we need to select a stem with maximal NWi (the most frequent word Wi) and assign it to root node. The input system in this case displays this most frequent word and place the cursor after it. If the word is desired one the user continues input of a next word, otherwise the user enters “<<” and system displays the second word with cursor after it and user continues input of a next word.

The root node has the valence more 2, then condition (3) becomes 2NTi>N, because NTi′=0.

To be valid, it's necessary that the number of all words starting at a letter Li is more then the number of all other possible words. This condition can be valid for only one initial letter Li of the stem having maximal NTi. So, is the most frequent letter has less then 50% of all words, then there are no guessing stems of length 1. Otherwise the stem Si of depth 1 corresponding to the most frequent letter is the optimal guessing stem of length 1.

So, summarizing these 2 cases, the subtree corresponding to the best guessing stem of depth 1, should have weight more the 50% of total weight the initial tree.

Now, let's consider stems having the depth k. The above condition becomes
(k+1)*NTi+NTi′>N (4)

The maximal value of (k+1)*NTi+NTi′ is reached for the stem Si with maximal weight NTi. Therefore to find the guessing stem Si of depth k, we should find the corresponding subtree Ti with maximal weight, and then check is the condition (4) valid. If not, there are no guessing stems of such depth. Otherwise Si is the best guessing stem of this depth.

Then the general algorithm of selection of the best guessing stem may looks as the following:

Stem=0; MaxValue=0;

for (D=1; D++; MaxDepth) {

Find the stem StemD of depth D having the maximal weight StemN;

StemValue=(D+1)*StemN+StemN′;/*StemN′ depends on valence of parent and determined above*/

```
  If ( StemValue > N ) {
    If ( StemValue > MaxValue ) {
      Stem=StemD; MaxValue=StemValue;
    }
  }
}
```

Therefore, to optimize the process of searching of a stems with maximal weight and to preserve simplicity of tree restructuring it is desirable to store in each node Ti the weight NTi of this node and arrange children of each parent node in decreasing order of NTi.

After running the process of the selection of the best guessing stem for all nodes of tree we may significantly reduce the number M of keystrokes necessary to enter all words comparing to the case of determinate stems.

Word Prediction

Another possible improvement is word prediction. At each moment the system may display (predict) the candidate word assigned to the current node (FIG. 14). If this candidate word is the desired word, then the user accepts it by OK command. If not, then a regular input process is continued.

The existing word prediction methods propose as the candidate word the most frequent possible word after some initial stem. In our terms the candidate word for a tree is a word from this tree having a maximal NW.

Such word prediction provides the reduction of the number M of keystrokes, but may be not optimal for global minimization of M.

Word Guessing

We propose another criterion for the selection of the candidate word.

Displaying of a candidate word Wi in the moment we reach a node Ti of T is equivalent to removal of this word as a terminal node and assignment it to the node Ti of the tree. If we want to accept this word being in the node Ti, then we enter OK event. If we enter any other input event we continue the regular input process.

The initial structure of input tree is illustrated at the FIG. 17. The total number of keystrokes M to enter all words is equal DWi*NWi+MT/Wi, where NWi is number of occurrences and DWi the depth of word Wi, and MT/Wi is the number of keystrokes necessary to input all other words. Let's T0 is the parent node for W.

Let's study what is the best terminal word W to assign to the given node. If we remove word W and assign it to node T, then the structure of the new tree T′ will be as illustrated at the FIG. 18.

The total number of keystrokes M′ to enter all words is equal NWi+MT/Wi, because we accept Wi by entering of OK, and need the same number of keystrokes for other words. We have additional bonus in the case if parent node T0 has valence 2. Then M′=NWi+MT/Wi−NWi′, where NWi′ is the weight of the sibling tree Ti′.

Therefore the reduction of number of keystrokes is equal: dWi=(DWi−1)*NWi+NWi′. So to select the best candidate word for the node we need to find a word with maximal value of dWi. This word may be not the most frequent word as for word prediction, so to differentiate this process we called it word guessing. Word guessing process takes in to account not only the frequency of words, but their length also.

The word guessing find the best candidate word for the root node, and the tree is restructured. Then we search a candidate words for all child nodes, and continue this process of tree restructuring for all nodes while we reach terminal nodes.

Let's note that if DWi=1 and the valence of the parent node T0 is more then 2, then dM=0. This situation is quite often when algorithm is approaching to terminal levels.

Combined Guessing

The next logical step is to combine processes of stem and word guessing. The second process depends on results of the first one so in order to get the maximal gain we may maximize the sum of dS+dWi for all stems and words simultaneously.

dM=dS+DWi=(DSi+1)*NTi+NTi′+(DWi−DSi−1)*NWi+NWi′−N; where Wi belongs to the subtree Ti of stem Si.

The special case of the combined guessing is if the stem Si is equal Wi (the stem reached the terminal node). We will call such stems as terminal stems. In this case the cursor is placed after the stem and the word and we may continue input of the next word without entering OK to accept the current word Wi. In this case dWi=0 and above formula looks like:
dM=dS+dWi=(DWi+1)*NWi+NWi′−N;

The preferred embodiment of combined processing executes the word guessing after the stem guessing at every node of T from top to bottom. This is the preferred, but only one of many possible combinations of stem and word guessing. The optimal combination may be different of this one.

Combined guessing requires two unambiguous input events for user control of input method: “OK” to accept a word guessing and “<<” to reject stem guessing.

Ambiguous Input

Input is ambiguous if input events have more then one input means. The set of input means for every input event is fixed a priori. For example, phone keyboard input is ambiguous, because every key has a group of several characters assigned to it. To specify the desired character the user should disambiguate it in the group. As it will be shown later, the disclosed above input guessing methods may be effectively combined with different disambiguating approaches and provide new, very efficient methods for ambiguous input.

Let's suppose that all notions determined above for unambiguous input preserve their meanings and designations. For example the depth of some word DW is a number of input events necessary to input this word.

There exists many disambiguating methods, but they may be classified into two main groups.

1) Methods of the first group resolve ambiguity immediately after every input event before processing to the next input event. This group includes multitap, LessTap, LetterWise, 4-directions and 2-clicks methods. Very often methods of the first group are called letter-level disambiguating methods.

2) Methods of the second group have delayed disambiguating and select input means basing on a sequence of input events. This group includes T9, eZiText, iTap methods. Known methods of the second group disambiguate all symbols of a word after the whole word was entered, so they also called word disambiguating methods. As it will be disclosed later delayed disambiguating may be effectively used even for uncompleted words and word stems.

Letter-Level Disambiguating Methods

These methods may be classified to sequential, direct and hierarchical methods, based on mechanism of access to the meanings.

a) Sequential methods switch sequentially between all meanings in some order. Multitap, LessTap and LetterWise belong to this group.

b) Direct or index methods based on access to meanings using indexes of meanings. 2-key method is an example of methods of this group.

c) Hierarchical methods use tree like hierarchical structures for access to meanings. 4-directional input method MDTIM using joystick belongs to this group.

Let's consider in details groups of immediate disambiguating methods.

Sequential Methods

These methods may be classified to fixed or dynamic ones, based of method of ordering of meanings in a group.

Static methods use pre-determined fixed order of meanings for all occurrence of input event. Multitap and LessTap are examples of fixed order sequential methods.

Dynamic methods create a new sequence of meanings for every occurrence of input event. LetterWise belongs to this group.

Any sequential method should have some unambiguous input event to switch between meanings. We will designate this event as “DIS” (or “ˆ”). This event maybe implemented using multiple taps of the same key or special disambiguating key. Ti is a subtree for i-th input meaning for input event.

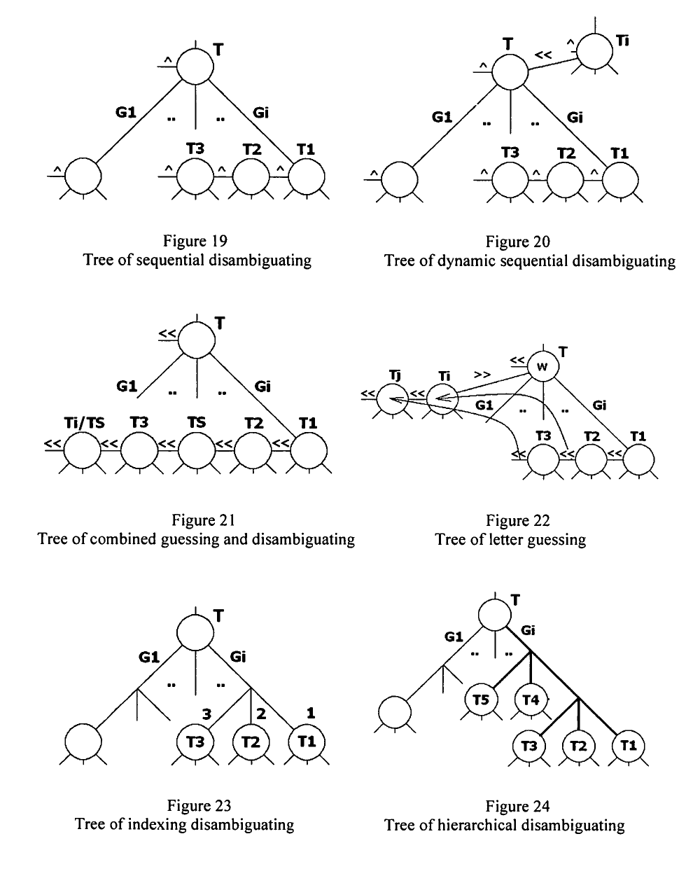

The input tree for sequential methods looks like one at the FIG. 19.

Dynamic Sequential Methods

As it was mentions above to apply guessing methods the input system should have 2 special unambiguous input events: “OK” and “<<”.

Let's study what is the best sequence of input meanings of an input event. The total number of keystrokes MGi to input all words for input event Gi is MT1+(NT2+MT2)+(2*NT3+MT3)+. . .

MGi is minimal is the sum NT2+2*NT3+3*NT4 is minimal. Therefore input meanings should be ordered in the decreasing of meaning (letter) weights.

Let's consider a process of guessing stem selection and tree restructuring for node T of the input tree. The total number MT of input events in T for the stem Si is equal to DSi*NTi+MTi+MT/Ti, where Ti is a subtree corresponding to stem Si. The structure of a new tree T′ is presented at the FIG. 20.

The number of input events MT′ in T′ is MT′=MTi+NT/Ti+MT/Ti−NTi′, where NTi′ is the total weight of all minor siblings of Ti. Note that NT/Ti=N−NTi and weights of all siblings of Ti didn't changed so we don't need to reorder them. To reduce the number of input events the following condition should be valid:
MT=DSi*NTi+MTi+MT/Ti>MTi+N−NTi+MT/Ti−NTi′=MT′;
dS=(DSi+1)*NTi+NTi′−N>0;

This expression has the same nature as condition (1) for unambiguous input so we may apply all above described methods for selection of the best guessing stem with simple corrections due to the different nature of NTi. We may select the stem S with the maximal positive value of dS.

The similar reasoning for selection of a best candidate word for word guessing process can be applied also. The order of some meanings for input events may be changed during tree restructuring due to changes of weights of subtrees of lower levels contained the candidate word. If the weight NTi of a subtree tree Ti contained the candidate word Wi becomes less then weight of some of its' minor siblings Tj, then Ti should be placed after Tj. That should be reflected in computation of MT′. This is quite simple process because at each level we have only one sibling contained Wi. Only these siblings should be reordered. So the total gain is equal to dWi=(DWi−1)*NWi−SUM(d′Ti*N′Ti−dTi*NTi), where the sum is by all Ti which changed its' positions at levels due reduction of weights of all subtrees contained Wi, dTi and d′Ti are old and new positions, and N′Ti and NTi are old and new weights. Note that N′Ti=NTi for all Ti didn't contain Wi, and N′Ti=NTi−NWi for subtrees contained Wi. We may select the word with maximal positive gain dWi.

The process of selection of best guessing words may be effectively combined with the process of best guessing stem selection as described above for unambiguous input. To do this we need to select stem and word to maximize dM=(dWi+dS). Again we have a special case for terminal stems, in this case DWi=0 and dM=dS+dWi=(DWi+1)*NWi+NTi′−N.

Therefore all methods for combined word and stem guessing may be applied for dynamic sequential disambiguating methods and provide a reduction of the total number of input events for ambiguous input.

Special cases of dynamic sequential trees may be considered if we combine input event of switching to another meaning “DIS” with some of input or control events of guessing system. The case of combining BACKWARD and DIS events is considered in the next chapter. Another preferred combination is to combine “DIS” event of dynamic trees with multiple inputs of the same group event. We will call it dynamic multitap. The first input of the group event shows the meaning with maximal weight, and every next input of the group event shows the next meaning in the order of weight decreasing. If no event was entered during some period, or another group event was entered, then system considers the last meaning as the desired meaning for the first input event. Therefore the order of meanings for the same input event may be different for every occurrence of this input event. The dynamic sequential method using dynamic multitap disambiguating and combined with input guessing is another preferred embodiment of the invention.

Combined Dynamic Sequential Guessing and Disambiguating

In the method described above we supposed that we have 3 control unambiguous events “OK”, “<<” and “DIS” for control of input system. We may joint “<<” and “DIS” events into one “<<” event, because they have a similar nature of rejection of some stem. Really, we could consider ambiguous letters as 1-letter guessing stems, and switching to the next letter as rejection of this stem.

This approach reduced the number of necessary unambiguous input events, simplifies user interface and combines guessing and disambiguating processes into one common process.

Then, after selection of a guessing stem, the structure of a new input tree T′ is presented at the FIG. 21.

The root tree Ti is divided into two trees TS corresponding to stem subtree and Ti/TS containing the rest of initial Ti. Then all siblings of Ti and these 2 new trees are reordered accordingly their, new weights. Since weights of all old siblings Tj didn't change they preserve their order, and only TS and Ti/TS should be inserted into this sequence accordingly their weights.

The total number of input events in the original tree is equal to: MT=SUM(MTj+dTj*NTj)+MTi/TS+dTi*NTi/TS+MTS+(dTi+DS)*NTS, where dTj is a number of position of the corresponding tree Tj in the sequence of siblings minus 1, and DS is depth of the stem S corresponding to TS.

The total number of input events MT′ in the new tree is equal to: MT′=SUM(MTj+d′Tj*NTj)+MTS+d′TS*NTS+MTi/TS+d′Ti/TS*NTi/TS−NTS′, where d′T is a number of position of the corresponding tree T in the new sequence of siblings minus 1. NTS′ is the total weight of all minor siblings of TSi in the original T.

To reduce the number of input events MT′ should be lesser then MT, or removing common part:
SUM(dTj*NTj)+(dTi+DS)*NTS+dTi*NTi/TS>SUM(d'Tj*NTj)+d′TS*NTS+d′Ti/TS*NTi/TS−NTS′ or
SUM(dTj*NTj)+(dTi+DS)*NTS+dTi*NTi/TS−SUM(d′Tj*NTj)−d′TS*NTS−d′Ti/TS*NTi/TS+NTS′>0
dS=DS*NTS+NTS′−SUM((d′Tj−dTj)*NTj)−(d′Ti/TS−dTi)*NTi/TS−(d′TS−dTi)*NTS>0 (5)
DS*NTS+NTS′>SUM((d′Tj−dTj)*NTj)+(d′Ti/TS−dTi)*NTi/TS+(d′TS−dTi)*NTS (6)

Note that NTi/TS=(NTi−NTS) above;

The left part looks similar to the corresponding part in the condition (2) for the unambiguous case. To calculate the sum in the right part we need to find relative displacement for all sibling in the new tree and then calculate how the number of “<<” events is changed. For members of the sum SUM((d′Tj−dTj)*NTj), values of (d′Tj−dTj) is equal −1, 0, +1.

If this condition is valid for the stem S, then this stem can be considered as a candidate for guessing stem for Ti. Then we may select a candidate stem with maximal positive value of dS (5).

After that, we select best guessing word for all new siblings. The process of selection of guessing word Wi for Ti doesn't change weights of siblings Tj, so we don't need to reorder them at this level, but it may change weights of subtrees Ti contained Wi at lower levels of Ti, so they should be restructured accordingly new weights. This process was described above for general dynamic trees. We may select guessing word with maximal value of dWi.

The process of selection of best guessing words should be combined with the process of best guessing stem selection as described above for unambiguous case. To maximize the total gain we should combine selection of guessing word and stem selection processes, because first one depends on selection of a stem. We need to maximize the value (dS+dWi) for all stems and words. Again we have a special case for terminal stems, in this case dWi=0 and S+dWi=DWi*NWi+NWi′−SUM((d′Tj−dTj)*NTj)−(d′Ti/Wi−dTi)*NTi/NWi−(d′Wi−dTi)*NWi

We continue above described processes of stem and word guessing recursively for all new siblings of T′ until no guessing stems can be selected, and then we proceed to lower levels.

As a result we build a new input tree combining guessing and disambiguating. This input tree implements a very simple user interface: the system displays the guessing word and places the cursor after the guessing stem. User can either reject the stem by entering “<<”, or accept the guessing word by entering “OK”, or continue input in the cursor position. After that the system displays a new word and position of the cursor and input process is continued.

Letter Guessing

The next possible step to reduce the total number of input events is based on the observation that the ambiguity of input event containing the letter at the cursor position may be further reduced. We may do this by adding a new unambiguous event “accept the letter at the position of the cursor” “>>”.

The structure of such tree is presented at FIG. 22. We transfer to the new “>>” branch all events having the same letter at the position of the cursor as the guessing word from the branch of input event containing this letter. We don't need to make a special reordering of siblings at both these branches, because they preserve initial relative order.

The gain is described by the following sum dL=SUM ((dTi−d′Ti)*NTi), where dTi and d′Ti are positions of all Ti in branches Gi and << in the initial and new trees.

To maximize the total gain we should combine this process with word and stem guessing processes, because it depends on a letter at the cursor position, and therefore depends on both these processes. We need to maximize the value dM=(dS+dWi+dL) for all stems and words. Wi belongs to the tree of the stem S and L is the letter of Wi in the position of the cursor.

We have the special cases for terminal stems. If dWi=0 or/and dL=0 and we use only the value of dS for maximization. Analogically if a stem is absent we use only dL and dS.

This tree implements the following input method: the system displays the guessing word and places the cursor after the guessing stem. User can either reject the stem by entering “<<”, or accept the guessing word by entering “OK”, or continue input in the cursor position, or move cursor forward by entering “>>”. After that the system displays a new word and position of the cursor and input process is continued.

The case of combined dynamic sequential guessing and disambiguating with letter guessing is one of preferred embodiments of the invention.

Static Sequential Methods

The processing of such trees and corresponding structures is similar to the case of dynamic methods. The only difference is that order of siblings is fixed and based on predetermined letter order. There are 2 main cases of ordering: alphabet order, which is used for Multitap input method, and non-alphabet orders, like LessTap based on letter frequencies (http://www.cs.yorku.ca/˜wolfgang/papers/lesstap.pdf).

As the order is fixed we don't need to rearrange siblings after their weights are changed. This simplifies processing and tree restructuring. All above described methods of input guessing may be applied to the case of static sequential disambiguating methods.

The proposed input guessing methods also may be used for calculation of optimal fixed non-alphabetic letter grouping and ordering minimizing overall number of keystrokes for a language for all possible layouts.

Indexing Methods

Indexing methods resolve ambiguity by direct indication of the position of desired meaning in the list of meanings for input event. Such methods are preferred if meaning lists are long, because sequential selection of meaning may require more input events. That happens if the lists have 4 or more meanings. This method is the preferred one for syllabic or ideographic languages, like Japanese, Chinese, Hindi, Thai and others.

The structure of the input tree for this method is presented at the FIG. 23.

We may apply to this tree all guessing techniques described above. Since the depth of words in this input tree is averagely doubled and it has more nodes, that may have even better effect for reduction of the number of input events.

The structure of the tree is very similar to the structure of the unambiguous input tree, and the reasoning is also similar and we have that:
dS=(DSi+1)*NTi+NTi′−N;
dWi=(DWi−1)*NWi+NWi′;
dL=NTL+NTL′;
where NTL is a weight of subtree corresponding to the letter in the cursor position.

All members with apostrophes appear if the parent node of the corresponding node of the stem, word or letter had valence 2.

We are maximizing the sum (dS+dWi+dL) for all nodes of the tree from top to bottom. Again we should specially consider cases of empty stem and if terminal stems dWi and dL are equal to zero.

Hierarchical Methods

Hierarchical methods resolve ambiguity using tree access to desired meaning in the list of meanings for input event. Such methods are preferred if meaning lists are long but the number of possible input events is too small for direct indexing. That happens, for example, for input devices with a few input buttons (pagers) or a few input states (d-pads or joysticks). Usually, hierarchical methods are combined with on-screen help to guide the user through the tree.

The generic structure of the input tree for hierarchical methods is presented at the FIG. 24. After each input event we reduce a set of possible input meanings. We will call these disambiguating trees as access trees.

Access trees may be fixed or dynamic ones. In the first case all access trees are the same for all input event. Indexing method may be considered as hierarchical method with fixed access tree of depth 1.

The structure of dynamic access trees may be different for each node of input tree and depends on weights of subtrees corresponding different input meanings. These trees should minimize the SUM(DM*NM) in each node, where DM is the depth of a meaning in the access tree and NM is the weight of all words belongs to this meaning. The theory of optimal access tree is well developed. For example, k-valence Huffman trees may be used as the optimal structure of such access trees, where k is the number of input events.

All methods of stem, word, and letter guessing may be applied to hierarchical input trees. The process of restructuring includes dynamic rebalancing of access trees contained guessing stem, word, and letters. This rebalancing is based on changed weights of trees. Formulas for the gains of number of events dS, dWi, dL are quite big, sophisticated and are not necessary because all these values calculated procedurally during tree restructuring.

We are maximizing the sum (dS+dWi+dL) for all nodes of the tree from top to bottom. Again for terminal stems dWi and dL are equal to zero.

Group Disambiguating

Methods of this type do not resolve letter ambiguity immediately after each input event, but try to disambiguate groups of input events. Usually such groups include all input events for some word, so they are also called word-level disambiguating or word prediction methods. Examples of methods of this type are: T9, eZiTap, iTap.

A node of the tree may have a list of word assigned to it. This list includes all words which may be entered by the sequence of input events from the root note of the tree to this node. The order of words within the list of words is determined by their weights. Upon reaching a node of the input tree, the input system displays the first word in the list of word assigned to that node. We may accept this word by “OK” command or reject it and switch to the next word in the list by “<<” command.

This tree is very similar to a tree for unambiguous input with the exception that a list of words may be assigned to a node instead of only one word as in the unambiguous case. This ambiguous tree may be created by joining of branches of an unambiguous tree assigned to one input event group.

Therefore, we may apply input guessing methods described above and combine switch and accept commands of disambiguating with reject and accept commands of guessing.

There are not any problems with application of word guessing, and we may assign to each node a best guessing word as we did for unambiguous case.

The number of keystrokes to enter a word using existing word prediction is M=(DWi+PWi+1)*NWi+M/Wi, where DWi is depth of word in the tree (usually equal to the length of word) and PWi is its position in the word list L assigned to the node containing Wi.

If the word Wi is assigned to node T then number of keystrokes is equal to: M′=NWi+M/Wi−NWi′, where NWi′ is the weight of all words in L after Wi. dWi=M−M′=(DWi+PWi)*NWi+NWi′→max.

Therefore, for every node of the initial input tree we may assign the word with maximal dWi.

Direct application of stem guessing looks difficult, because stem guessing predict a stem after determinate part of the word, but the word displayed by group guessing input method may have no determinate stem at the beginning and whole part of the word before cursor including guessing stem may differ from the corresponding part of the desired word, so it is not clear for the user what part of a word and at what moments he needs to reject. Therefore, possible implementation of true stem guessing should indicate the guessed stem (for example by different color) and that makes the user interface for stem guessing quite sophisticated.

Nevertheless, some if the sequence of input events leads to determinate word or stem, then the cursor maybe forwarded to the position after the determinate stem without additional confirmation from user. Such behavior will not surprise the user because this is the only possible continuation of input. This is quite frequent case for a long words and nodes at the lower levels of the input tree.

Another good situation is terminal stems, because in this situation the cursor is placed after the word and user easily understand what he may reject (the whole word) and when (when the cursor is after the word).

In this case M′=NM/Wi+M/Wi−NWi′=(N−NWi)+M/Wi−NWi′ and dWi=0, so we maximize dSWi=(DWi+PWi+2)*NWi+NWi′−N.

Comparing to the word guessing to use the word for the terminal stem guessing is more efficient then as just guessing word, if dSWi>dWi, or 2NWi>N. That means that Wi should have more then 50% of occurrences of all possible at that moment words. That may happen for only one word, so we need to analyze the terminal stem only if a word has more then 50% of all possible words, and check dWi for maximum in all other cases.

User interface remains similar to the regular group guessing: if the cursor is placed after the word, then if the words is desired the user continues input, if not—enter “<<” to switch to the next state; if cursor is within the word and the displayed word is the desired one—accept it by “OK”, if not—enter the next input event of the desired word in the position of the cursor. This input guessing methods inherits the common issue of group disambiguating to display sequences, which may very differ from desired one.

If the interface is still difficult for user, he may switch off terminal stem prediction and leave only word guessing.

The case of combined group disambiguating and guessing is another preferred embodiment of the invention.

Dynamic Ambiguous Input

Input is dynamic ambiguous if some of input event may have more then one input mean and a set of input means for such events may be different each time. The typical examples are miniature keyboard if several keys may be activated simultaneously, handwriting or gesture input if several letters or strokes have similar shapes, voice input of similar sounds, etc.

Most of the methods described above for fixed ambiguous input may be applied for dynamic input. Due to the random nature of meanings sets the corresponding input tree should have a simple dynamic structure. The most suited method is event level disambiguating based on dynamic sequential trees in case if input events are easily separated and the user may make corrections after every input event (keyboard, block letters or gestures) and group disambiguating if corrections of individual events is difficult or unacceptable by ergonomics reasons (voice input or cursive handwriting).

In the first case the input tree is build dynamically before each input event and is a part of the tree for unambiguous input corresponding to all possible words. Therefore all methods of guessing described above for unambiguous input are applied to optimization of dynamic ambiguous input in this case and it may use the structure of the optimal input tree for the unambiguous input.

At the second case we also can use the part of optimal tree for unambiguous input which contains all words possible at each moment of input.

We considered many cases of input processes and corresponding trees, but above disclosed ideas may be applied generally for optimization of any processes described by sequences of events.

That which is claimed:

1. An input guessing system for guessing sequences of input, comprising a processor; wherein the processor is capable of accepting a plurality of input events on an input device of the system, each of the plurality of input events being associated with inputs, and wherein the processor is capable of generating a candidate sequence of input and placing the cursor position within or after the candidate sequence in the response to every input event in a sequence of input events and capable of presenting an object associated with the candidate sequence, wherein the candidate sequences and the cursor positions are selected to minimize a total number of input events necessary for input of all sequences of input weighted accordingly their priority which are possible after previous input events.

2. The input guessing system of claim 1, wherein the input events may comprise one or more of keystrokes, gestures, strokes, handwritings, sounds, and images; and wherein the input may comprise one or more of letters, digits, punctuation marks, icons, and phonetic or graphic elements of symbols from any language, including syllabic and ideographic languages; and wherein sequences of input comprise one or more of words, phrases, numbers, terms, abbreviations, commands, names, or identifications.

3. The input guessing system of claim 1, wherein the input event disambiguating may be either processed before or combined with generating a candidate sequence by the input guessing system.

4. The input guessing system of claim 1, wherein the priority of a sequence of input is determined by a frequency of use, a number of occurrences of the sequence in a large corpus of sequences, or a numeric value characterizing an object associated with a sequence.

5. The input guessing system of claim 1, wherein all possible sequences and their stems are stored in a dictionary together with their priority values; and wherein the dictionary has a tree-like structure.

6. The input guessing system of claim 1, wherein the dictionary is stored in the form of a state tree; wherein every node of the tree contains a state of the input guessing system including a candidate sequence and the cursor position; and wherein every branch corresponds to input event and connects two nodes if system changes it's state from a first node state to a second node state after the branch input event.

7. The input guessing system of claim 1, wherein the dictionary of possible sequences depend on an application, a context, and a user preference; wherein the sequences are added to or removed from the dictionary, and wherein corresponding changes of priorities are made in the dictionary.

8. The input guessing system of claim 1, wherein the system has unambiguous cursor control input events, including, but not limited to, OK, BACKWARD and FORWARD, wherein OK accepts the current candidate sequence if the cursor is within the current candidate sequence, and BACK or FORWARD are used to indicate the position of the first incorrect symbol in the sequence in relation to the displayed cursor position.

9. The input guessing system of claim 1, wherein the system has unambiguous control input events, including, but not limited to, OK, BACKWARD and FORWARD, wherein BACKWARD rejects the part of the sequence before the cursor, FORWARD accepts the letter at the position of the cursor, and OK accepts the whole sequence.

10. The input guessing system of claim 1, wherein the cursor placement is controlled by a user by the direct indication of a desired position of the cursor with respect to the current candidate sequence.

11. The input guessing system of claim 10, wherein the direct cursor placement is combined with symbol input into one stroke, wherein the initial point of a stroke determines the position of the cursor toward the word and the stroke determines the desired symbol input; wherein strokes represents a set of most expected symbols in this position for this word.

12. The input guessing system of claim 1, wherein the system is switching to per symbol prediction mode based on priorities of n-grams of input, if a non-dictionary sequence was entered.

13. The input guessing system of claim 1, wherein the system proposes a proper spelling of a candidate sequence if a non-dictionary sequence was entered.

14. The input guessing system of claim 1, wherein the system is switched into editing or undo mode if the cursor is positioned by a user into an unambiguous part of the current candidate sequence.

15. The input guessing system of claim 1, wherein the system utilizes information about possible pairs and combinations of sequences and types of sequences, and expectancy of these combinations for the generation of a candidate sequence.

16. The input guessing system of claim 1, wherein a user has access to a limited group of input events with highest priority and is capable of switching to next groups of events with lower priorities using unambiguous NEXT input event, which is present at any group.

17. The input guessing system of claim 1, wherein the system comprise a data entry system on a portable electronic device, wherein the portable electronic device is selected from the group consisting of a mobile phone, a smart phone, a pager, a portable data terminal, a personal data assistants (PDA), a portable audio or video player, a portable medical device, a portable personal computer (PC), a portable global positioning system (GPS) receiver, an electronic dictionary, an electronic translator, a personal information manager, a labeler, and a smart watch.

18. The input guessing system of claim 1, wherein the system comprise a data entry system on a fixed electronic device, wherein the fixed electronic device is selected from the group consisting of a desktop computer (PC), remote terminals, mounted devices, equipment control devices, avionics, car computer systems, info booths, public terminals.

19. A method of performing input guessing, comprising the iterative steps of:
generating an input candidate sequence;
placing a cursor at a symbol position within or after the candidate sequence;
accepting entry of a next input event at the position of the cursor, if the cursor is placed in the position of the first incorrect symbol; and
accepting cursor displacement to the correct position of the first incorrect symbol, if the cursor is not placed in the position of the first incorrect symbol.

20. A computer program product for performing input guessing, wherein the computer program product comprises a computer-readable storage medium having computer-readable program code embodied in the medium, and wherein the computer-readable program code comprises:
a primary code for executing one or more of the functions of claim 1, and wherein the primary code comprises:
a first code for generating an input candidate sequence;
a second code for placing a cursor at a symbol position within or after the candidate sequence;
a third code for accepting entry of a next input event at the position of the cursor, if the cursor is placed in the position of the first incorrect symbol; and
a fourth code for accepting cursor displacement to the correct position of the first incorrect symbol, if the cursor is not placed in the position of the first incorrect symbol.
